(19) United States
(12) Patent Application Publication
(10) Pub. No.: US 2018/0336136 A1
(43) Pub. Date: Nov. 22, 2018

(54) Input/output-coherent Look-ahead Cache Access

(71) Applicant: QUALCOMM Incorporated, San Diego, CA (US)

(72) Inventors: Farrukh HIJAZ, San Diego, CA (US); Andrew Edmund TURNER, San Diego, CA (US); Bohuslav RYCHLIK, San Diego, CA (US)

(21) Appl. No.: 15/645,294

(22) Filed: Jul. 10, 2017

Related U.S. Application Data
(60) Provisional application No. 62/507,651, filed on May 17, 2017.

(51) Int. Cl. G06F 12/0862; G06F 12/02

(52) U.S. Cl. CPC G06F 12/0862; G06F 12/084; G06F 2212/602; G06F 12/0215

(57) ABSTRACT

Aspects include computing devices, apparatus, and methods implemented by the apparatus for input/output-coherent look-ahead cache access on a computing device. The aspects may include intercepting, at a look-ahead device, a look-ahead request for data in a cache of a first input/output (I/O) device from a second I/O device, determining, by the look-ahead device, whether the data requested by the look-ahead request is stored in the cache, retrieving, by the look-ahead device, the data requested by the look-ahead request from the cache in response to determining that the data requested by the look-ahead request is stored in the cache, marking the data requested by the look-ahead request as invalid in the cache, and storing, by the look-ahead device, the retrieved data to a look-ahead buffer

### CROSS-REFERENCE TO RELATED APPLICATIONS

This application claims the benefit of priority under C.F.R. 371(c) of U.S. Provisional Application No. 62/507,651 entitled “Input/output-coherent Look-ahead Cache Access” filed May 17, 2017, the entire contents of which are hereby incorporated by reference.

### BACKGROUND

In multi-processor computing devices executing multiple threads, masters with real-time requirements (high priority masters) have to compete with other low priority masters for cache resources. The interference from low priority cache accesses can result in substantial increase in access latency for more critical cache accesses. Off-the-shelf caches generally process access requests in a first-come-first-serve order, causing high priority cache access requests to queue up behind low priority cache access requests. This queuing of high priority cache access requests can be detrimental for cache accesses associated with real-time processes or requirements if the high priority cache access requests queue up behind several non-critical cache accesses, resulting in high access latency for critical cache accesses.

### SUMMARY OF THE INVENTION

Various aspects and implementations include methods of input/output-coherent look-ahead cache access on a computing devices. Various aspects may include a look-ahead device receiving a first look-ahead request for data in a cache of a first input/output (I/O) device from a second I/O device, determining whether the data requested by the first look-ahead request is stored in the cache, retrieving the data requested by the first look-ahead request from the cache in response to determining that the data requested by the first look-ahead request is stored in the cache, and storing the retrieved data to a look-ahead buffer.

Some aspects may include the look-ahead device receiving a cache access request for data in the cache of the first I/O device from the second I/O device, determining whether the data requested by the cache access request is stored in the look-ahead buffer, and returning the data requested by the cache access request to the first I/O device from the look-ahead buffer in response to determining that the data requested by the cache access request is stored in the look-ahead buffer.

Some aspects may include the look-ahead device receiving a second look-ahead request for data in the cache of the first input/output (I/O) device, determining whether the data requested by the second look-ahead request is the same as the data stored in the look-ahead buffer and requested by the first look-ahead request, and evicting the data from the look-ahead buffer in response to determining that the data requested by the second look-ahead request is not the same as the data stored on the look-ahead buffer and requested in the first look-ahead request. In such aspects, the look-ahead device may receive a cache access request for data in the cache of the first I/O device from a third I/O device, determine whether the data requested by the cache access request is the same as the data requested by the first look-ahead request, and send the cache access request to a shared memory in response to determining that the data requested by the cache access request is the same as the data requested by the first look-ahead request.

Some aspects may include the look-ahead device receiving a cache access request for data in the cache of the first I/O device from the second I/O device before retrieving the data requested by the first look-ahead request from the cache, in which the data requested by the cache access request is the same as the data requested by the first look-ahead request, queuing the cache access request by the look-ahead device, and returning the data requested by the cache access request to the first I/O device in response to retrieving the data requested by the first look-ahead request from the cache.

Some aspects may include the look-ahead device receiving a coherency state transition request from the cache for the same location in the cache as the first look-ahead request, and returning the data from the look-ahead buffer to the cache. In some aspects, the look-ahead device may maintain the data in the look-ahead buffer as stale data, receiving a cache access request for data in the cache of the first I/O device from the second I/O device, determining whether the data requested by the cache access request is the stale data stored in the look-ahead buffer, and returning the data requested by the cache access request to the first I/O device from the look-ahead buffer in response to determining that the data requested by the cache access request is the stale data stored in the look-ahead buffer.

In some other aspects, the look-ahead device may identify a synchronization command for the cache, and mark the data stored in the look-ahead buffer as invalid. In such aspects, the look-ahead device may retrieve the data requested by the first look-ahead request from the cache a second time in response to data stored in the look-ahead buffer being marked as invalid, and store the second time retrieved data to a look-ahead buffer. In other such aspects, the look-ahead device may receive a cache access request for data in the cache of the first I/O device from the second I/O device, and send the cache access request to the cache.

Further aspects may include a look-ahead device receiving a look-ahead request for data in a cache of a first input/output (I/O) device from a second I/O device, and determining whether the data requested by the look-ahead request is stored in the cache.

Some aspects may include the look-ahead device dropping the look-ahead request in response to determining that the data requested by the look-ahead request is not stored in the cache, receiving a cache access request for data in the cache of the first I/O device from the second I/O device, in which the data requested by the cache access request is the same as the data requested by the look-ahead request, and sending the cache access request to a shared memory.

Some aspects may include the look-ahead device sending the look-ahead request to a shared memory, and receiving a cache access request for data in the cache of the first I/O device from the second I/O device, in which the data requested by the cache access request is the same as the data requested by the look-ahead request. Such aspects may further include queuing the cache access request by the look-ahead device, and returning the data requested by the cache access request to the first I/O device in response to retrieving the data requested by the look-ahead request from the shared memory.

Some aspects may include the look-ahead device retrieving the data requested by the look-ahead request from the cache in response to determining that the data requested by the look-ahead request is stored in the cache, marking the data requested by the look-ahead request in the cache as invalid, sending a shared memory access request to write the data requested by the look-ahead request to a shared memory, receiving a cache access request for data in the cache of the first I/O device from the second I/O device, in which the data requested by the cache access request is the same as the data requested by the look-ahead request, determining whether the data requested by the cache access request is stored in the cache, and sending the cache access request to a shared memory in response to determining that the data requested by the cache access request is not stored in the cache.

Various aspects include a computing device including a look-ahead device having a look-ahead buffer, a first input/output (I/O) device having a cache, and a second I/O device, to perform operations of methods summarized below. In some aspects, the first computing device may be within an automobile. Various aspects include a computing device including means for performing functions of methods summarized below. Various aspects include a non-transitory processor-readable medium on which is stored processor-executable instructions configured to cause a processor of a computing device to perform operations of methods summarized below.

### BRIEF DESCRIPTION OF THE DRAWINGS

The accompanying drawings, which are incorporated herein and constitute part of this specification, illustrate example aspects of various aspects, and together with the general description given above and the detailed description given below, serve to explain the features of the claims.

FIG. 1 is a component block diagram illustrating a computing device suitable for implementing various aspects.

FIG. 2 is a component block diagram illustrating an example multi-core processor suitable for implementing various aspects.

FIG. 3 is a component block diagram illustrating an example system on chip (SoC) suitable for implementing various aspects.

FIG. 4 is a component block diagram illustrating an example computing device having input/output devices including multiple processors, subsystems, and/or components in accordance with various aspects.

FIG. 5 is a block diagram illustrating an example heterogeneous computing device with a look-ahead device suitable for implementing various aspects.

FIGS. 6A-6M are component interaction flow diagrams illustrating examples of operation flows for input/output-coherent look-ahead cache access according to various aspects.

FIG. 7 is a component interaction flow diagram illustrating an example of an operation flow for input/output-coherent look-ahead cache access according to some aspects.

FIGS. 8A-8D are component interaction flow diagrams illustrating examples of operation flows for input/output-coherent look-ahead cache access according to various aspects.

FIG. 9 is a process flow diagram illustrating a method for implementing input/output-coherent look-ahead cache access according to an aspect.

FIG. 10 is a process flow diagram illustrating a method for implementing input/output-coherent look-ahead cache access according to an aspect.

FIG. 11 is a process flow diagram illustrating a method for implementing input/output-coherent look-ahead cache access according to an aspect.

FIG. 12 is a process flow diagram illustrating a method for implementing input/output-coherent look-ahead cache access according to an aspect.

FIG. 13 is a process flow diagram illustrating a method for implementing input/output-coherent look-ahead cache access according to an aspect.

FIG. 14 is a process flow diagram illustrating a method for implementing input/output-coherent look-ahead cache access according to an aspect.

FIG. 15 is a process flow diagram illustrating a method for implementing input/output-coherent look-ahead cache access according to an aspect.

FIG. 16 is a process flow diagram illustrating a method for implementing input/output-coherent look-ahead cache access according to an aspect.

FIG. 17 is a process flow diagram illustrating a method for implementing input/output-coherent look-ahead cache access according to an aspect.

FIG. 18 is a process flow diagram illustrating a method for implementing input/output-coherent look-ahead cache access according to an aspect.

FIG. 19 is a process flow diagram illustrating a method for implementing input/output-coherent look-ahead cache access according to an aspect.

FIG. 20 is a process flow diagram illustrating a method for implementing input/output-coherent look-ahead cache access according to an aspect.

FIG. 21 is component interaction flow diagrams illustrating an example operation flow for input/output-coherent look-ahead cache access according to various aspects.

FIG. 22 is a process flow diagram illustrating a method for implementing input/output-coherent look-ahead cache access according to an aspect.

FIG. 23 is a component block diagram illustrating an example mobile computing device suitable for use with the various aspects.

FIG. 24 is a component block diagram illustrating an example mobile computing device suitable for use with the various aspects.

FIG. 25 is a component block diagram illustrating an example server suitable for use with the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various aspects may include methods, and systems and devices implementing such methods, for input/output-coherent look-ahead cache access for improved access speed of a first input/output (I/O) device to data stored in a cache of a second I/O device. The device and methods of the various aspects may include receiving or intercepting a look-ahead request to the cache of the second I/O device, determining whether data requested by the look-ahead request is stored in the cache, retrieving the data from the cache or a shared memory depending on whether the data is stored in the cache, and storing the data in a look-ahead buffer for responding to a later cache access request for the data.

The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The term “computing device” may further refer to stationary computing devices including personal computers, desktop computers, all-in-one computers, workstations, super computers, mainframe computers, embedded computers, servers, home theater computers, and game consoles.

In various aspects, special look-ahead requests from an I/O device to a memory device, such as a cache, may be used to determine whether speculatively required data is stored in the memory device. The look-ahead requests may include requests for data that is not expected to be returned to the requesting I/O device in response to the look-ahead request, but that has a chance of being retrieved from the memory device by a later cache access request. In various aspects, a hardware component, such as a look-ahead device, may be included in a computing device on a communication bus between an I/O device and memory devices, such as a cache of another I/O device. The look-ahead device may be configured to receive the look-ahead requests and process them to improve the access time of the data requested by the look-ahead request and possibly by a future access request. The look-ahead device may attempt to retrieve the data requested by the look-ahead request from various memory devices, including the I/O device cache and/or a shared memory. The look-ahead device may be associated with a small memory device, such as a look-ahead buffer, configured to store retrieved data requested by the look-ahead request. In various aspects, an I/O device may issue a cache access request for the same data as a prior look-ahead request. The look-ahead device may be configured to receive the cache access request and return the look-ahead data stored in the look-ahead buffer to the I/O device. The prior processing of the look-ahead request for data matching the data requested by the cache access request allows for access to the data without having to spend time retrieving the data requested from the I/O device cache or the shared memory after receiving the cache access request.

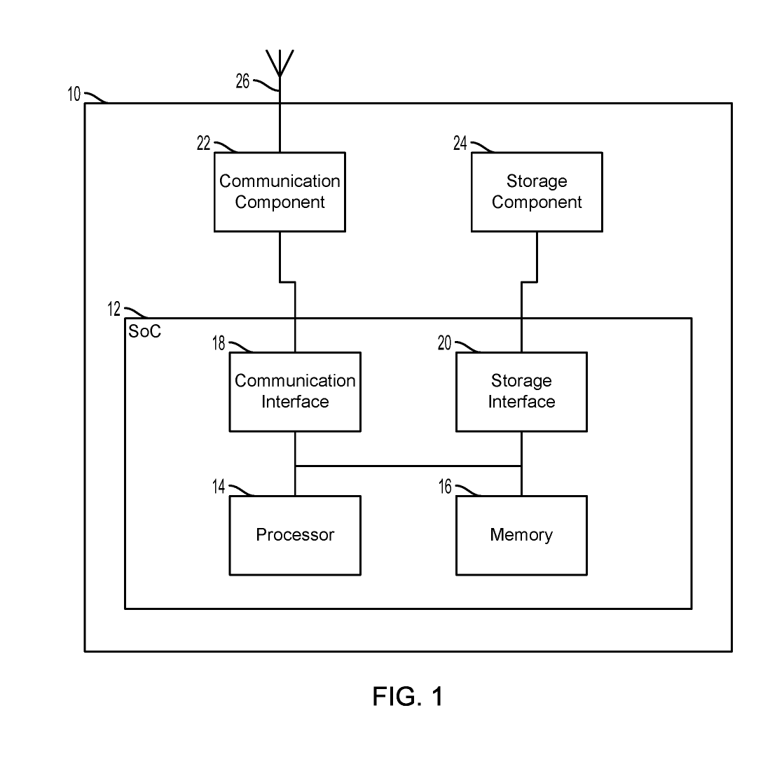

FIG. 1 illustrates a system including a computing device 10 suitable for use with the various aspects. The computing device 10 may include a system-on-chip (SoC) 12 with a processor 14, a memory 16, a communication interface 18, and a storage memory interface 20. The computing device 10 may further include a communication component 22, such as a wired or wireless modem, a storage memory 24, and an antenna 26 for establishing a wireless communication link. The processor 14 may include any of a variety of processing devices, for example a number of processor cores.

The term “system-on-chip” (SoC) is used herein to refer to a set of interconnected electronic circuits typically, but not exclusively, including a processing device, a memory, and a communication interface. A processing device may include a variety of different types of processors 14 and processor cores, such as a general purpose processor, a central processing unit (CPU), a digital signal processor (DSP), a graphics processing unit (GPU), an accelerated processing unit (APU), an auxiliary processor, a single-core processor, and a multicore processor. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

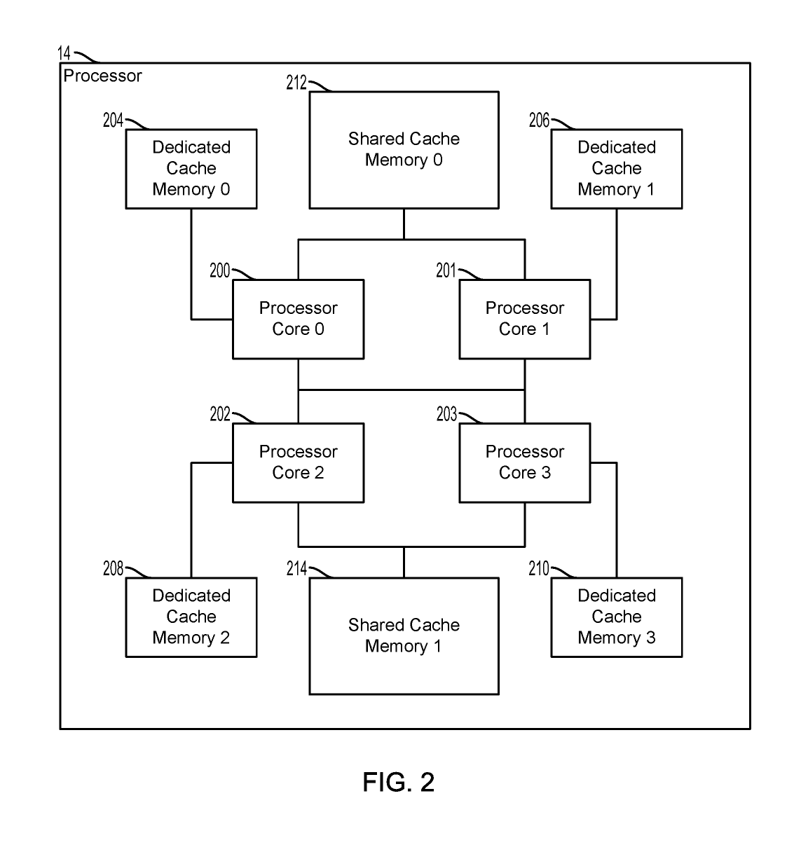

An SoC 12 may include one or more processors 14. The computing device 10 may include more than one SoC 12, thereby increasing the number of processors 14 and processor cores. The computing device 10 may also include processors 14 that are not associated with an SoC 12. Individual processors 14 may be multicore processors as described below with reference to FIG. 2. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster.

The memory 16 of the SoC 12 may be a volatile or non-volatile memory configured for storing data and processor-executable code for access by the processor 14. The computing device 10 and/or SoC 12 may include one or more memories 16 configured for various purposes. One or more memories 16 may include volatile memories such as random access memory (RAM) or main memory, or cache memory. These memories 16 may be configured to temporarily hold a limited amount of data received from a data sensor or subsystem, data and/or processor-executable code instructions that are requested from non-volatile memory, loaded to the memories 16 from non-volatile memory in anticipation of future access based on a variety of factors, and/or intermediary processing data and/or processor-executable code instructions produced by the processor 14 and temporarily stored for future quick access without being stored in non-volatile memory.

The memory 16 may be configured to store data and processor-executable code, at least temporarily, that is loaded to the memory 16 from another memory device, such as another memory 16 or storage memory 24, for access by one or more of the processors 14. The data or processor-executable code loaded to the memory 16 may be loaded in response to execution of a function by the processor 14. Loading the data or processor-executable code to the memory 16 in response to execution of a function may result from a memory access request to the memory 16 that is unsuccessful, or a “miss,” because the requested data or processor-executable code is not located in the memory 16. In response to a miss, a memory access request to another memory 16 or storage memory 24 may be made to load the requested data or processor-executable code from the other memory 16 or storage memory 24 to the memory device 16. Loading the data or processor-executable code to the memory 16 in response to execution of a function may result from a memory access request to another memory 16 or storage memory 24, and the data or processor-executable code may be loaded to the memory 16 for later access.

The storage memory interface 20 and the storage memory 24 may work in unison to allow the computing device 10 to store data and processor-executable code on a non-volatile storage medium. The storage memory 24 may be configured much like an aspect of the memory 16 in which the storage memory 24 may store the data or processor-executable code for access by one or more of the processors 14. The storage memory 24, being non-volatile, may retain the information after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

Some or all of the components of the computing device 10 may be arranged differently and/or combined while still serving the functions of the various aspects. The computing device 10 may not be limited to one of each of the components, and multiple instances of each component may be included in various configurations of the computing device 10.

FIG. 2 illustrates a multicore processor suitable for implementing an aspect. The multicore processor 14 may include multiple processor types, including, for example, a CPU and various hardware accelerators, including for example, a GPU and/or a DSP. The multicore processor 14 may also include a custom hardware accelerator, which may include custom processing hardware and/or general purpose hardware configured to implement a specialized set of functions.

The multicore processor may have a plurality of homogeneous or heterogeneous processor cores 200, 201, 202, 203. A homogeneous multicore processor may include a plurality of homogeneous processor cores. The processor cores 200, 201, 202, 203 may be homogeneous in that, the processor cores 200, 201, 202, 203 of the multicore processor 14 may be configured for the same purpose and have the same or similar performance characteristics. For example, the multicore processor 14 may be a general purpose processor, and the processor cores 200, 201, 202, 203 may be homogeneous general purpose processor cores. The multicore processor 14 may be a GPU or a DSP, and the processor cores 200, 201, 202, 203 may be homogeneous graphics processor cores or digital signal processor cores, respectively. The multicore processor 14 may be a custom hardware accelerator with homogeneous processor cores 200, 201, 202, 203.

A heterogeneous multicore processor may include a plurality of heterogeneous processor cores. The processor cores 200, 201, 202, 203 may be heterogeneous in that the processor cores 200, 201, 202, 203 of the multicore processor 14 may be configured for different purposes and/or have different performance characteristics. The heterogeneity of such heterogeneous processor cores may include different instruction set architecture, pipelines, operating frequencies, etc. An example of such heterogeneous processor cores may include what are known as “big.LITTLE” architectures in which slower, low-power processor cores may be coupled with more powerful and power-hungry processor cores. In similar aspects, an SoC (for example, SoC 12 of FIG. 1) may include any number of homogeneous or heterogeneous multicore processors 14. In various aspects, not all off the processor cores 200, 201, 202, 203 need to be heterogeneous processor cores, as a heterogeneous multicore processor may include any combination of processor cores 200, 201, 202, 203 including at least one heterogeneous processor core.

In an aspect, the processor cores 200, 201, 202, 203 may have associated dedicated cache memories 204, 206, 208, 210. Like the memory 16 in FIG. 1, dedicated cache memories 204, 206, 208, 210 may be configured to temporarily hold a limited amount of data and/or processor-executable code instructions that is requested from non-volatile memory or loaded from non-volatile memory in anticipation of future access. The dedicated cache memories 204, 206, 208, 210 may also be configured to store intermediary processing data and/or processor-executable code instructions produced by the processor cores 200, 201, 202, 203, and temporarily store data for future quick access without the need for such data to be stored in non-volatile memory. Each dedicated cache memory 204, 206, 208, 210 may be associated with one of the processor cores 200, 201, 202, 203. Each dedicated cache memory 204, 206, 208, 210 may be accessed by its respective associated processor core 200, 201, 202, 203. In the example illustrated in FIG. 2, each processor core 200, 201, 202, 203 is in communication with one of the dedicated cache memories 204, 206, 208, 210 (e.g., processor core 0 is paired with dedicated cache memory 0, processor core 1 with dedicated cache memory 1, processor core 2 with dedicated cache memory 2, and processor core 3 with dedicated cache memory 3). Each processor core 200, 201, 202, 203 is shown to be in communication with only one dedicated cache memory 204, 206, 208, 210; however, the number of dedicated cache memories is not meant to be limiting and may vary for each processor core 200, 201, 202, 203.

In an aspect, the processor cores 200, 201, 202, 203 may have associated shared cache memories 212, 214. The shared cache memories 212, 214 may be configured to perform similar functions to the dedicated cache memory 204, 206, 208, 210. However, the shared cache memories 212, 214 may each be in communication with more than one of the processor cores 200, 201, 202, 203 (e.g., processor core 0 and processor core 1 are paired with shared cache memory 0, and processor core 2 and processor core 3 are paired with shared cache memory 1). Each processor core 200, 201, 202, 203 is shown to be in communication with only one shared cache memory 212, 214; however, the number of shared cache memories is not meant to be limiting and may vary for each processor core 200, 201, 202, 203. Similarly, each shared cache memory is shown to be in communication with only two processor cores 200, 201, 202, 203; however, the number of processor cores is not meant to be limiting and may vary for each shared cache memory 212, 214. The processor cores 200, 201, 202, 203 in communication with the same shared cache memory 212, 214, may be grouped together in a processor cluster as described further herein.

In the example illustrated in FIG. 2, the multicore processor 14 includes four processor cores 200, 201, 202, 203 (i.e., processor core 0, processor core 1, processor core 2, and processor core 3). In the example, each processor core 200, 201, 202, 203 is designated a respective dedicated cache memory 204, 206, 208, 210 (i.e., processor core 0 and dedicated cache memory 0, processor core 1 and dedicated cache memory 1, processor core 2 and dedicated cache memory 2, and processor core 3 and dedicated cache memory 3). For ease of explanation, the examples described herein may refer to the four processor cores 200, 201, 202, 203 and the four dedicated cache memory 204, 206, 208, 210 illustrated in FIG. 2. However, the four processor cores 200, 201, 202, 203 and the four dedicated cache memory 204, 206, 208, 210 illustrated in FIG. 2 and described herein are merely provided as an example and in no way are meant to limit the claims to a four-core processor system with four designated private caches. The computing device 10, the SoC 12, or the multicore processor 14 may individually or in combination include fewer or more than the four processor cores 200, 201, 202, 203 and dedicated cache memory 204, 206, 208, 210 illustrated and described herein. For ease of reference, the terms “hardware accelerator,” “custom hardware accelerator,” “multicore processor,” “processor,” and “processor core” may be used interchangeably herein.

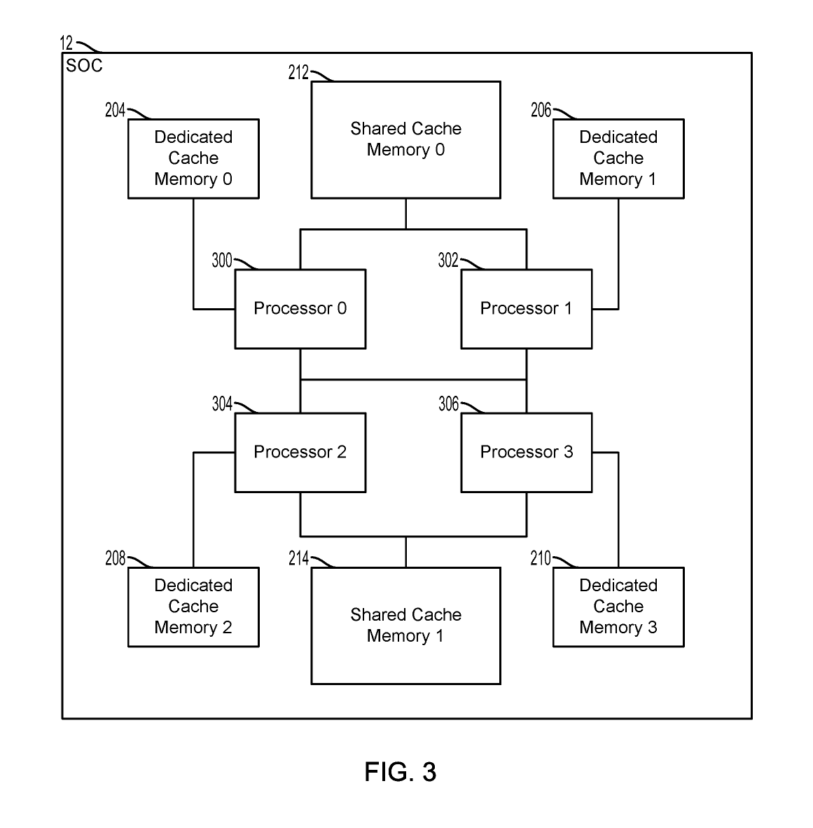

FIG. 3 illustrates an SoC 12 suitable for implementing an aspect. The SoC 12 may have a plurality of homogeneous or heterogeneous processors 300, 302, 304, 306. Each of the processors 300, 302, 304, 306 may be similar to the processor 14 in FIG. 2. The purposes and/or performance characteristics of each processor 300, 302, 304, 306 may determine whether the processors 300, 302, 304, 306 are homogeneous or heterogeneous in a similar manner as the processor cores 200, 201, 202, 203 in FIG. 2.

The dedicated cache memories 204, 206, 208, 210 and shared cache memories 212, 214 are also similar to the same components described in FIG. 2; however, in the example illustrated in FIG. 3 the dedicated cache memories 204, 206, 208, 210 and shared cache memories 212, 214 are in communication with the processors 300, 302, 304, 306. The number and configuration of the components of the SoC 12 is not meant to be limiting, and the SoC 12 may include more or fewer of any of the components in varying arrangements.

The processors and processor cores described herein need not be located on the same SoC or processor to share a shared cache memory. The processors and processor cores may be distributed across various components while maintaining a connection to the same shared cache memory as one or more other processors or processor cores.

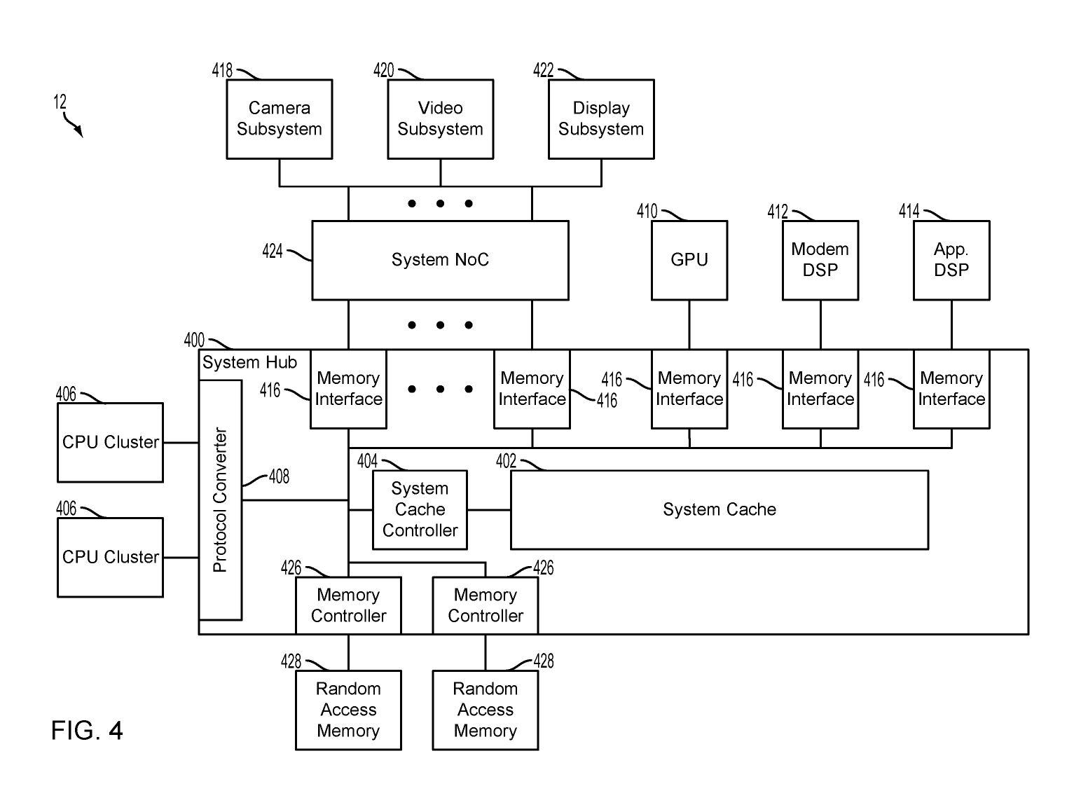

FIG. 4 illustrates a computing device with multiple I/O devices suitable for implementing an aspect. With reference to FIGS. 1-4, the SoC 12 may include a variety of components as described above. Some such components and additional components may be employed to implement input/output-coherent look-ahead cache access operations (described further herein). For example, an SoC 12 configured to implement input/output-coherent look-ahead cache access may include various communication components configured to communicatively connect the components of the SoC 12 that may transmit, receive, and share data. The communication components may include a system hub 400, a protocol converter 408, and a system network on chip (NoC) 424. The communication components may facilitate communication between I/O devices, such as processors (e.g., processor 14 in FIGS. 1-3) in CPU clusters 406 and various subsystems, such as camera, video, and display subsystems 418, 420, 422, and may also include other specialized processors such as a GPU 410, a modem DSP 412, an application DSP 414, and other hardware accelerators. The communication components may facilitate communication between the I/O devices and various memory devices, including a system cache 402, a random access memory (RAM) 428, various memories included in the CPU clusters 406 and the various subsystems 418, 420, 422, such as caches (e.g., dedicated cache memories 204, 206, 208, 210 and shared cache memories 212, 214 in FIGS. 2 and 3). Various memory control devices, such as a system cache controller 404, a memory interface 416, and a memory controller 426, may be configured to control access to the various memories by the I/O devices and implement operations for the various memories, which may be requested by the I/O devices.

The descriptions herein of SoC 12 and its various components are only meant to be exemplary and in no way limiting. Several of the components of the SoC 12 may be variably configured, combined, and separated. Several of the components may be included in greater or fewer numbers, and may be located and connected differently within the SoC 12 or separate from the SoC 12. Similarly, numerous other components, such as other memories, processors, subsystems, interfaces, and controllers, may be included in the SoC 12 and in communication with the system cache controller 404 in order to access the system cache 402.

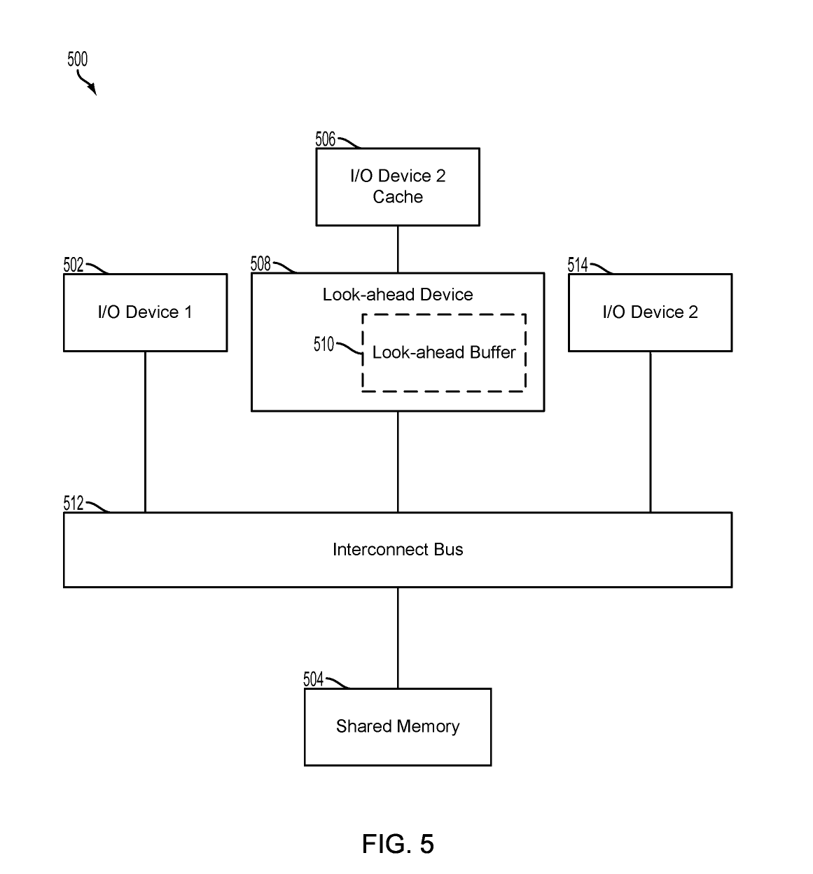

FIG. 5 illustrates an example aspect of a heterogeneous computing device 500 with a look-ahead device 508. A heterogeneous computing device 500 (e.g., the computing device 10 illustrated in FIG. 1) may include any combination of components as described herein with reference to FIGS. 1-5. Such components may include various I/O devices 502, 514 (e.g., I/O device 1 and I/O device 2) that may include any combination of processors (e.g., processor 14 in FIGS. 1-3, CPU cluster 406, GPU 410, DSP 412, 414 in FIG. 4) subsystems (e.g., camera subsystem 4118, video subsystem 420, display subsystem 422 in FIG. 4), and/or components configured to request data from an I/O device cache 506 (e.g., I/O device 2 cache, dedicated cache memories 204, 206, 208, 210 and shared cache memories 212, 214 in FIGS. 2 and 3). In particular, the I/O devices 502, 514 may be configured to request data from the I/O device cache 506 of another I/O device 502, 514. For example, the I/O device cache 506 may be associated (logically and/or physically) with the I/O device 514, and the I/O device 502 may be configured to request data from the I/O device cache 506. As another example, the I/O device 502 may be associated with another I/O device cache (not shown), but may request from the I/O device cache 506 data that is not available to the I/O device cache associates with the I/O device 502.

The heterogeneous computing device 500 may also include a shared memory 504, a look-ahead device 508, which may optionally include a look-ahead buffer 510, and an interconnect bus 512. The shared memory 504 may be any memory device that is accessible by multiple I/O devices 502, 514 (e.g., memory 16, 24 in FIG. 1, shared cache memory 212, 214 in FIGS. 2 and 3, system cache 402, and random access memory 428 in FIG. 4). The interconnect bus 512 may be configured to communicatively connect the components of the heterogeneous computing device 500, including the I/O devices 502/514, the shared memory 504, and the look-ahead device 508 including the look-ahead buffer 510.

In various aspects, the look-ahead device 508 may be communicatively connected between the I/O device 502 and the I/O device cache 506. Other connections to the I/O device cache 506 through the look-ahead device 508 are possible, including with other I/O devices, even the I/O device 514 associated with the I/O device cache 506. In various aspects, any number of look-ahead devices 508 may be communicatively connected between any number of I/O devices 502, 514, and I/O device caches 506. Example ratios of device relationships of I/O devices 502, 514 to look-ahead devices 508 to I/O device caches 506 may include: one to one to one; one to many to one; one to one to many; one to many to many; many to one to one; many to many to one; many to one to many; and many to many to many. Further, similar various relationships may be configured for the I/O devices 502, 514, and the I/O device caches 506 to the look-ahead buffer 510 of any look-ahead device 506. In other words, the look-ahead device may include any number of look-ahead buffers that may be associated with any number of the I/O devices 502, 514, and/or the I/O device caches 506. For ease of explanation and brevity, unless stated otherwise, the descriptions herein are stated in terms of the example of the I/O device 502 making cache access requests to the I/O device cache 506. This is not meant to limit the claims and any I/O device 502, 514, may be configured to interact with the I/O device cache 506, the look-ahead device 508, the look-ahead buffer 510, and/or the shared memory 504 as described herein.

The I/O device 502 may make cache access requests to the I/O device cache 506. Such cache access requests typically result in checking or snooping (herein, the terms checking and snooping are used interchangeably) the cache to determine whether the requested data is in the cache, and, either, retrieving and returning the requested data from the I/O device cache 506 to the I/O device 502, or sending the access request to the shared memory when the data cannot be found in the I/O device cache 506. All of these steps typically occur in response to the access request.

However, the I/O device 502 may be given priority over other I/O devices because its tasks are more critical to the operation of the heterogeneous computing device 500. In various aspects, to improve performance of the I/O device 502 having priority above other I/O devices, the I/O device 502 may be configured to send look-ahead requests to improve the accessibility of the data the I/O device 502 may require from the I/O device cache 506. A look-ahead request may be a speculative request for data from the I/O device cache 506 that the I/O device 502 may require for future operations. For example, the I/O device 502 may be executing an application code that generally requires certain data from the I/O device cache 506, and the I/O device 502 may send a look-ahead request for such data in advance of when it is needed for processing. This data may be commonly stored in the I/O device cache 506 and likely available when it is needed by the I/O device 502. The look-ahead request may trigger the look-ahead device 508 to retrieve the data from the I/O device cache 506 and store it in the look-ahead buffer 510, which is a smaller, more quickly accessible memory, as described further herein. This data may alternatively be more likely not available in the I/O device cache 506 and not easily accessible when the I/O device 502 needs it. Such data may require more time to retrieve from the shared memory 504 when not available in the I/O device memory 506. The I/O device 502 may send the look-ahead request to prompt retrieval by the look-ahead device 508 of the data having higher latency for access to reduce the access latency when the data is needed by the I/O device 502. However, it is not necessary that the I/O device 502 ends up needing the data after it is retrieved by the look-ahead device 508. The I/O device 502 may send the look-ahead request for data with variable probability that the data will be needed. The look-ahead request allows for retrieval of data prior to a speculative need by the I/O device 502 to reduce the access latency if the data is eventually needed. The look-ahead request may be signified by a bit setting in a bus message for the look-ahead request.

The look-ahead device 508 may be configured to receive look-ahead requests and retrieve the requested data to make it more readily available to the I/O device 502 sending the look-ahead request in a look-ahead buffer 510 than if the data remained stored in the I/O device cache 506 or the shared memory 504 in the event the I/O device 502 later sends a cache access request for the same data. The look-ahead device 508 may be configured to receive/intercept look-ahead requests sent by the I/O device 502 to the I/O device cache 506 associated with the look-ahead device 506. A look-ahead request may specify data speculatively by specifying a target address of the I/O device cache 506 where the data is expected to be located. The look-ahead device 508 may recognize the data request as a look-ahead request and process the look-ahead requests appropriately, in comparison to how the look-ahead device 508 may process other data requests, like a cache access request as discussed further herein.

The look-ahead device 508 may check or snoop the I/O device cache 506 to determine whether the requested data is stored at the location in the I/O device cache 506 specified by the look-ahead request. In various aspects, in response to determining that the requested data is located at the location in the I/O device cache 506 specified by look-ahead request, the look-ahead device 508 may retrieve the data from the I/O device cache 506 and store the data and/or the address of the I/O device cache 506 for the data in the look-ahead buffer 510. In response to determining that the requested data is not located at the location in the I/O device cache 506 specified by look-ahead request, the look-ahead device 508 may retrieve the data from the shared memory 504 and store the data in the look-ahead buffer 510. In various aspects, in response to determining that the requested data is located at the location in the I/O device cache 506 specified by look-ahead request, the look-ahead device 508 may retrieve the data from the I/O device cache 506 and send a write request for the data to the shared memory 504. Detailed descriptions of these and other various manners the look-ahead device 508 may operate in response to different scenarios are provided herein.

The look-ahead buffer 510 may be a small memory dedicated for use by the look-ahead device 508 for storing data retrieved in response to a look-ahead request and/or the address of the I/O device cache 506 for the data. In various aspects, the look-ahead buffer 510 may be a content addressable memory configured with a limited number of entries customizable for a particular implementation. For example, an implementation for use with a single I/O device cache 506 may include eight to ten entries. In various aspects, the look-ahead buffer 510 may be a high-level cache. In various aspects, the look-ahead buffer 510 may be fully coherent, and may be referred to as a coherent quality of service (QoS) guaranteed cache. The look-ahead device 508 may manage the look-ahead buffer 510, controlling reads from, writes to, and replacement polices for the look-ahead buffer 510.

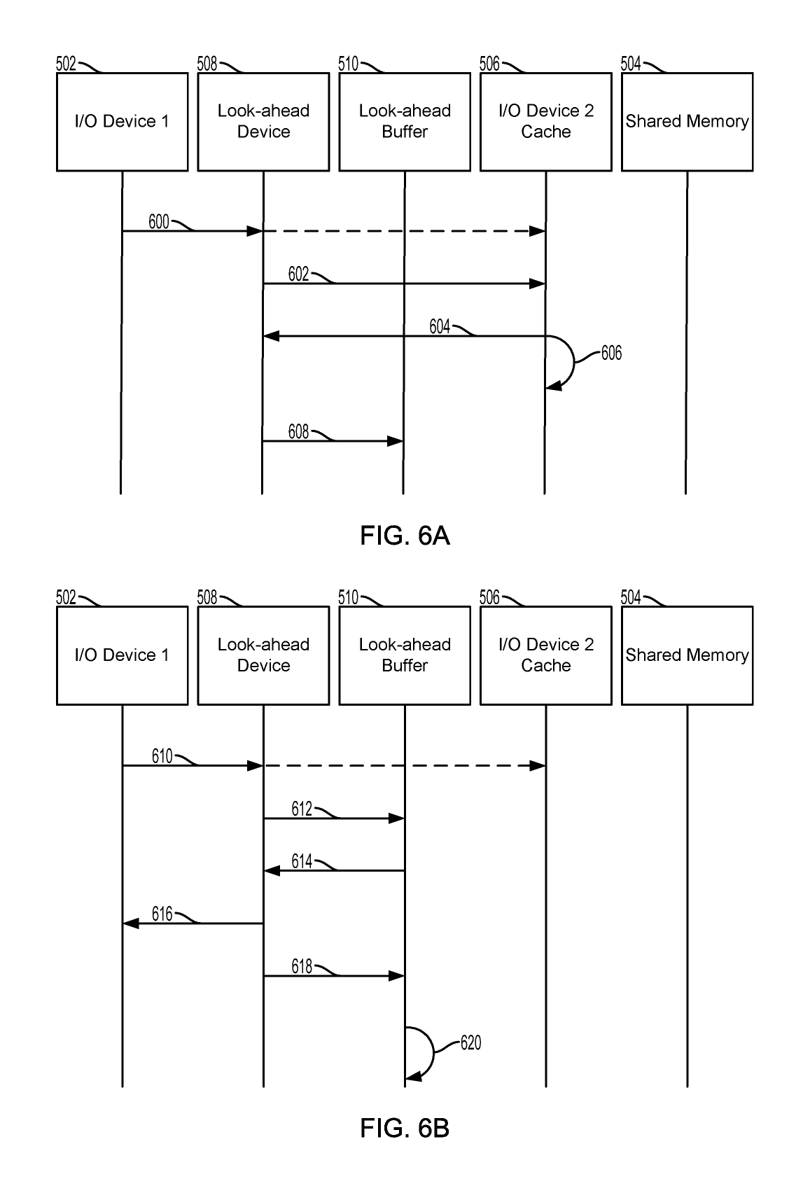

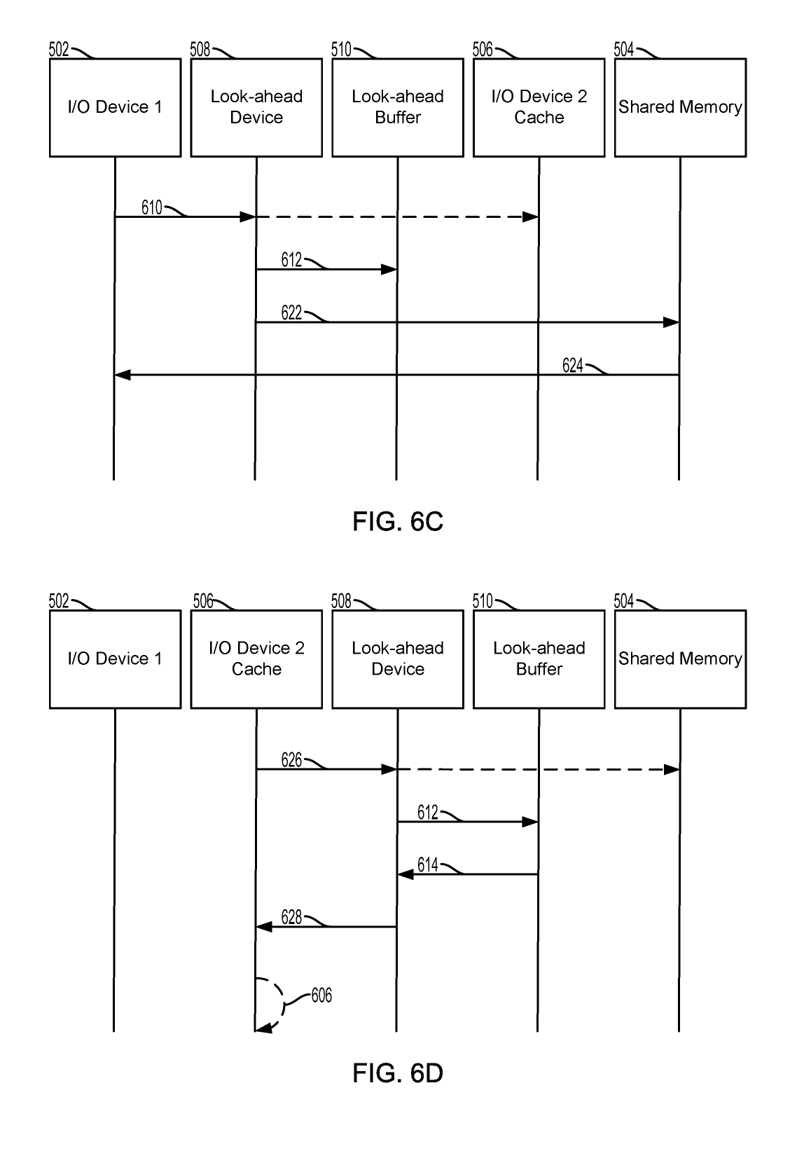

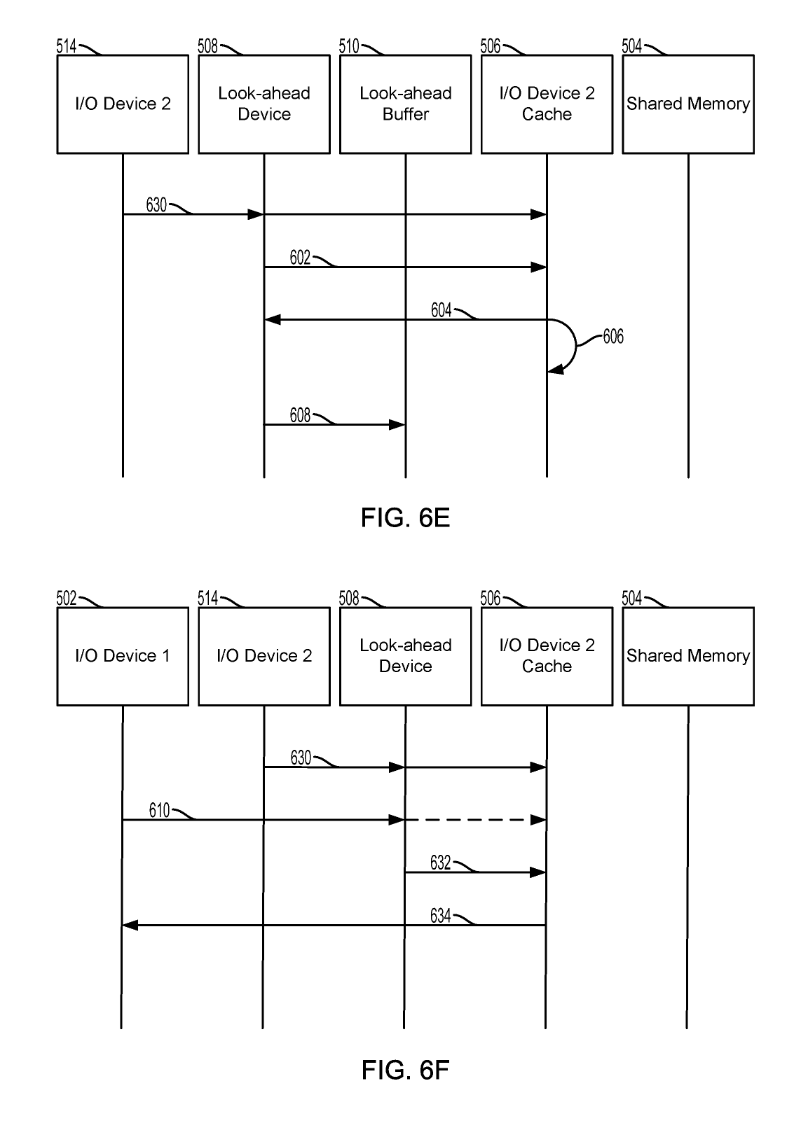

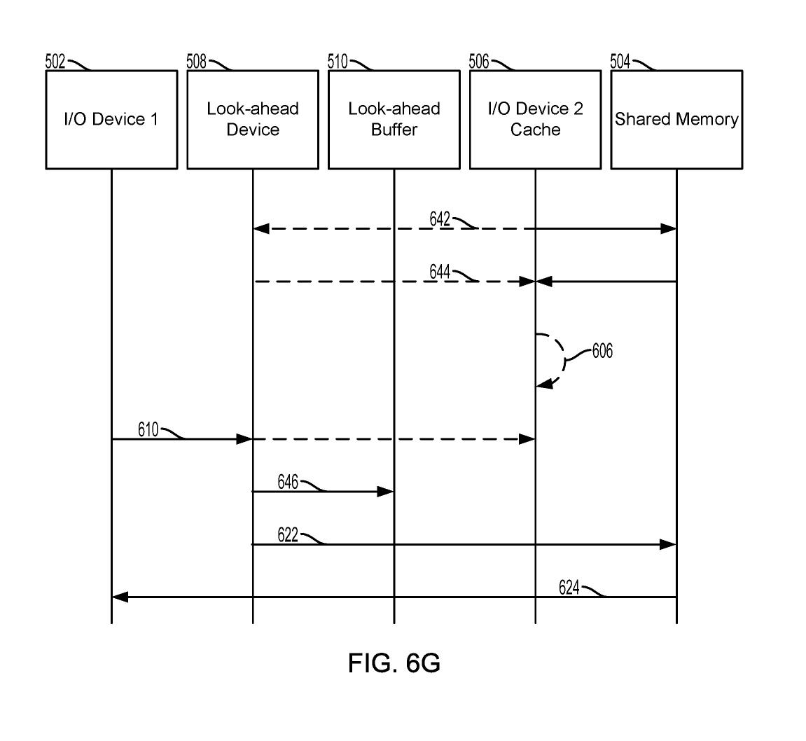

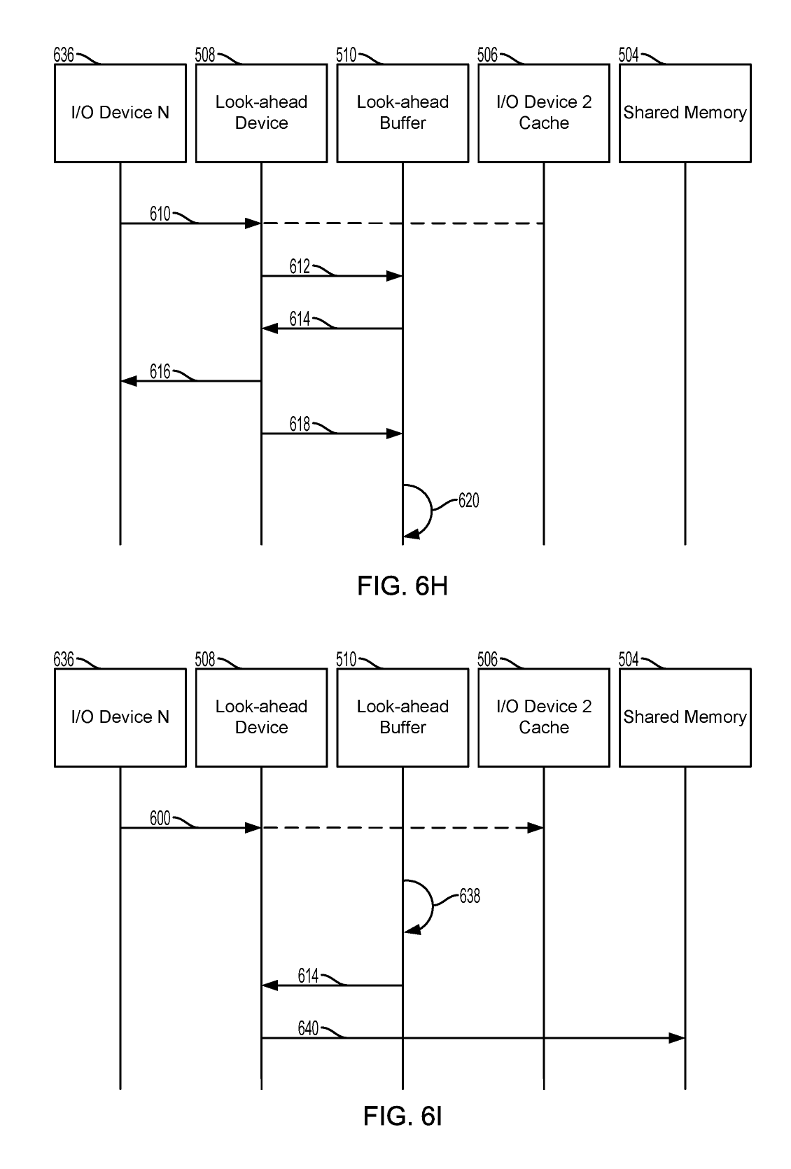

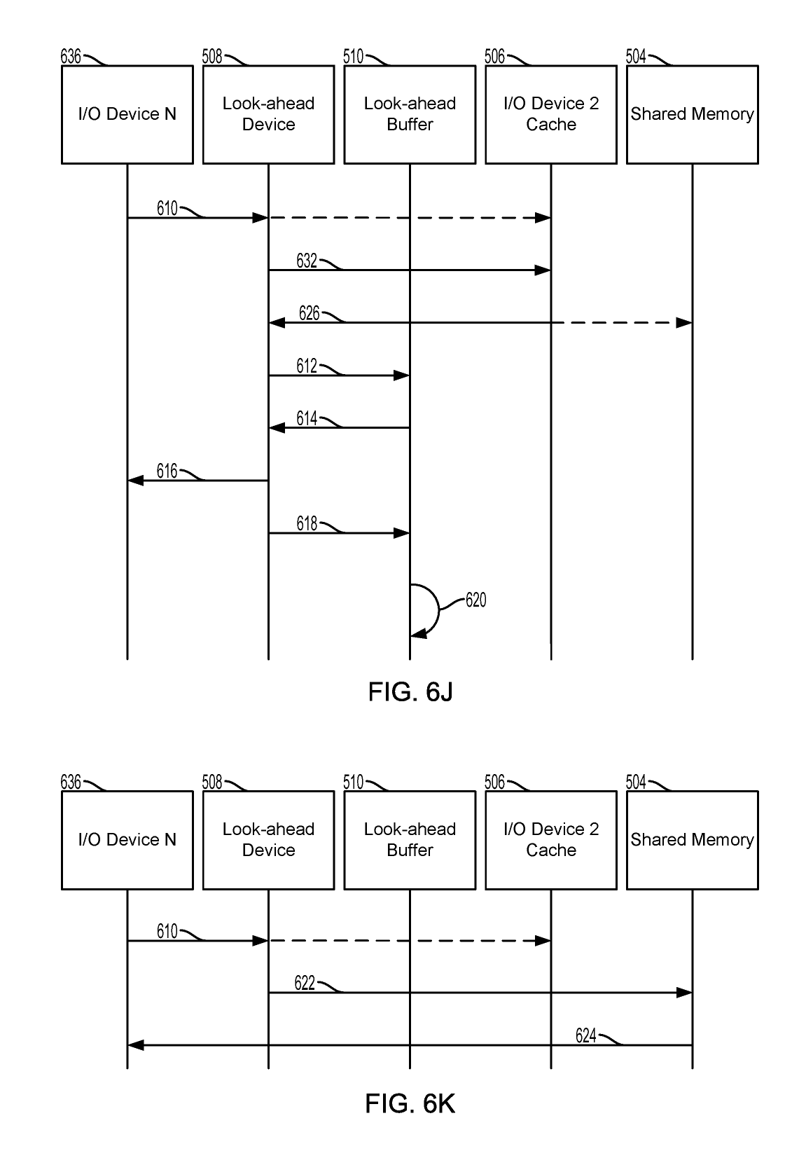

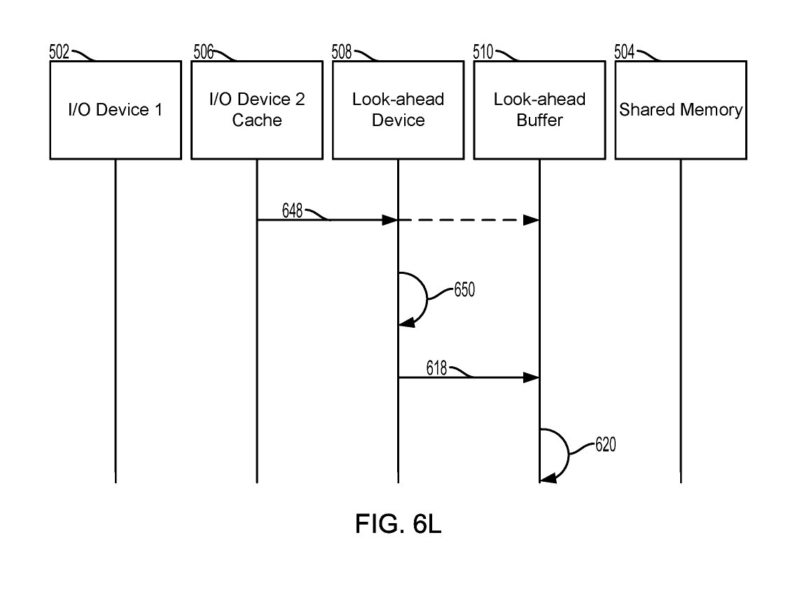

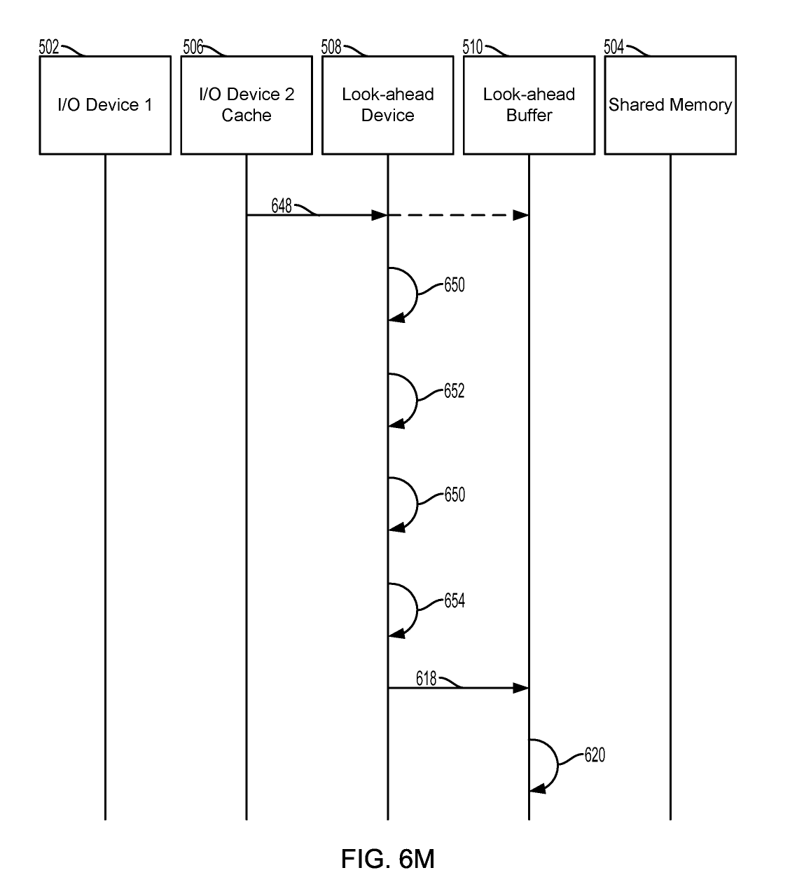

FIGS. 6A-6M illustrate examples of operation and data flows for input/output-coherent look-ahead cache access using a look-ahead device implementing an aspect. The examples illustrated in FIGS. 6A-6M relate to the structures of the components illustrated in FIGS. 1-6. The I/O device 502, 514, shared memory 504, I/O device cache 506, look-ahead device 508, and look-ahead device buffer 510 are used as examples for ease of explanation and brevity, but are not meant to limit the claims to the illustrated number and/or types of I/O devices (e.g., processor 14 in FIGS. 1-3, CPU cluster 406, GPU 410, DSP 412, 414, camera subsystem 418, video subsystem 420, display subsystem 422 in FIG. 4) or memory devices (e.g., memory 16, 24 in FIG. 1, dedicated cache memories 204, 206, 208, 210 and shared cache memories 212, 214 in FIGS. 2 and 3, system cache 402, and random access memory 428 in FIG. 4). Further, the order of the operations and signals 600-640 is used as an example for ease of explanation and brevity, but is not meant to limit the claims to a particular order of execution of the operations and signals 600-640 as several of the operations and signals 600-640 may be implemented in parallel and in other orders.

The example illustrated in FIG. 6A represents processing a look-ahead request that results in finding the requested data in the I/O device cache 506 (otherwise known as a “hit” in the I/O device cache 506). The I/O device 502 may send a look-ahead request to the I/O device cache 506. During transmission of the look-ahead request, the look-ahead device 508 may receive 600 the look-ahead request. In various aspects, the look-ahead device 508 may intercept the look-ahead request, since the look-ahead request may be targeted for receipt by the I/O device cache 506 but first captured by the look-ahead device 508 before arriving at the I/O device cache 506. The terms receive and intercept are used interchangeably herein in relation to look-ahead requests.

The look-ahead device 508 may check 602 whether the I/O device cache 506 contains the requested data at the location in the I/O device cache 506 specified by the look-ahead request. Checking 602 the I/O device cache location may include the process of snooping the location of the I/O device cache 506. In response to determining from the check 602 that the I/O device cache 506 contains the requested data at the location in the I/O device cache 506 specified by the look-ahead request, the look-ahead device 508 may retrieve 604 the requested data from the I/O device cache 506 or an indication that the requested data is stored at the location in the I/O device cache 506. In various aspects, the look-ahead device 508 may retrieve 604 the requested data by requesting the data from the I/O device cache 506 and receiving the return data response from the I/O device cache 506. The request for the data from the I/O device cache 506 may also include a request to mark the data in the I/O device cache 506 as invalid. Responding to the request to check for the data of the look-ahead device 508 with the return data or indication response may prompt the I/O device cache 506 to mark 606 the data in the cache as invalid or shared. After receiving the return data or indication response from the I/O device cache 506, the look-ahead device 508 may store 608 the requested data and/or the address of the I/O device cache 506 for the data to the look-ahead buffer 510. In various aspects, the look-ahead buffer 510 may be fully coherent. In various aspects, the look-ahead device 508 may control the look-ahead buffer 510 and write the requested data and/or the address of the I/O device cache 506 for the data to the look-ahead buffer 510. In various aspects, the requested data and/or the address of the I/O device cache 506 for the data stored in the look-ahead buffer 510 may remain stored in the look-ahead buffer until evicted, as described further herein.

The example illustrated in FIG. 6B represents processing a cache access request that results in finding the requested data in the look-ahead buffer 510 (sometimes referred to as a “hit”). In various aspects, the example illustrated in FIG. 6B may occur a short time after the example illustrated in FIG. 6A. The I/O device 502 may send a cache access request to the I/O device cache 506. During transmission of the cache access request, the look-ahead device 508 may receive 610 the cache access request. In various aspects, the look-ahead device 508 may intercept the cache access request, since the cache access request may be targeted for receipt by the I/O device cache 506 but first captured by the look-ahead device 508 before arriving at the I/O device cache 506.

The look-ahead device 508 may check 612 whether the look-ahead buffer 510 contains the requested data specified in the cache access request. In various aspects, the look-ahead device 508 may compare the location for the requested data in the I/O device cache 506 specified by the cache access request with the location of the data in the I/O device cache 506 from which the data was stored in the look-ahead buffer 510 to determine whether the requested data is the same as the data stored in the look-ahead buffer 510. The look-ahead device 508 may compare other information relating to the requested and stored data that may positively identify whether the requested and stored data are the same.

In response to determining from the check 612 that the requested data specified by the cache access request and the data stored in the look-ahead buffer 510 are the same, the look-ahead device 508 may retrieve 614 the requested data from the look-ahead buffer 510. In various aspects, the look-ahead device 508 may retrieve 614 the requested data by reading the data from the look-ahead buffer 510. While and/or after retrieving 614 the requested data from the look-ahead buffer 510, the look-ahead device 508 may return 616 the requested data to the I/O device 502 that sent the cache access request. Returning 616 the requested data to the I/O device 502 that sent the cache access request may generally indicate that the look-ahead request served its purpose of making the requested data available for a later cache access request for the data. The usefulness of the data stored in the look-ahead buffer 510 may be diminished following the return 616 of the requested data. The look-ahead device 506 may mark 620 or prompt 618 the look-ahead buffer 510 to mark 620 the requested data stored in the look-ahead buffer 510 as invalid. In various aspects, operations other than marking 620 the data invalid may be used to prevent use of the data stored in the look-ahead buffer 510, such as overwriting data in the look-ahead buffer 510 or deenergizing the look-ahead buffer 510 so that the data is not retained.

The example illustrated in FIG. 6C represents processing a cache access request that results in not finding the requested data in the look-ahead buffer 510 (sometimes referred to as a “miss”). For numerous reasons, the look-ahead request may have failed to produce the requested data for storing in the look-ahead buffer 510, or the requested data may have been in the look-ahead buffer 510 at one point but is no longer stored in the look-ahead buffer 510. For example, the requested data may not have been stored in the I/O device cache 506 and was not retrieved by the look-ahead device 508. In another example, the requested data may have been evicted from the look-ahead buffer 510 before a cache access request for the data.

The I/O device 502 may send a cache access request to the I/O device cache 506. During transmission of the cache access request, the look-ahead device 508 may receive 610 the cache access request. The look-ahead device 508 may check 612 whether the look-ahead buffer 510 contains the requested data specified in the cache access request. In response to determining from the check 612 that the requested data specified by the cache access request is not stored in the look-ahead buffer 510, the look-ahead device 508 may send 622 the cache access request to the shared memory 504. In various aspects, the look-ahead device 508 may send or forward the received cache access request by duplicating and sending the message signals of the cache access request. The shared memory 504 may locate the requested data in the shared memory 504 and return 624 the requested data to the I/O device 502 that originally issued the cache access request. In various aspects, the return 624 of the requested data may be direct between the shared memory 504 and the I/O device 502 as the return 624 of the requested data does not affect anything for the look-ahead buffer 510. This direct return 624 may be possible because of the duplication of the messaging signals of the cache access request that may identify the I/O device 502 as the source of the cache access request. In various aspects, the return 624 of the requested data may be routed through the look-ahead device 508.

The example illustrated in FIG. 6D represents processing a coherency state transition request from the I/O device cache 506, following processing a look-ahead request that results in finding the requested data in the I/O device cache 506, as described with reference to FIG. 6A. The I/O device cache 506 may issue a coherency state transition request for itself at the same location in the I/O device cache 506 as the requested data for the look-ahead request previously processed. The coherency state transition request may seek to change a state of the data previously stored at the location in the I/O device cache 506 from the shared memory 504 via a shared memory access request since the data had been marked 606 invalid or shared as a result of the successful look-ahead request. The requested state change may be from invalid or shared to modified. During retrieval of the data from the shared memory 504, the look-ahead device 508 may receive 626 the shared memory access request. In various aspects, the look-ahead device 508 may intercept the shared memory access request, since the shared memory access request may be targeted for receipt by the shared memory 504 but first captured by the look-ahead device 508 before arriving at the shared memory 504.

The look-ahead device 508 may check 612 whether the look-ahead buffer 510 contains the requested data specified in the shared memory access request. In various aspects, the look-ahead device 508 may compare the location for the requested data for the I/O device cache 506 specified by the cache access request with the location of the data in the I/O device cache 506 from which the data was stored in the look-ahead buffer 510 to determine whether the requested data is the same as the data stored in the look-ahead buffer 510. The look-ahead device 508 may compare other information relating to the requested and stored data that may positively identify whether the requested and stored data are the same.

In response to determining from the check 612 that the requested data specified by the shared memory access request and the data stored in the look-ahead buffer 510 are the same, the look-ahead device 508 may retrieve 614 the requested data from the look-ahead buffer 510. In various aspects, the look-ahead device 508 may retrieve 614 the requested data by reading the data from the look-ahead buffer 510. While and/or after retrieving 614 the requested data from the look-ahead buffer 510, the look-ahead device 508 may return 628 the requested data to the I/O device cache 506. The coherency state transition request may include a write request that may update the data written to the I/O device cache 506, which may make the data stored in the look-ahead buffer 510 stale data since it is not the most recent copy of the data stored at the location in the I/O device cache 506. Stale data may still be useable for I/O-coherency, as long as there is not a forced invalidation of the I/O device cache 506 due to a synchronization instruction. Even while storing stale data, the components may respond to a cache access request in the manner of processing a cache access request that results in finding the requested data in the look-ahead buffer 510 described with reference to the example in FIG. 6B.

In various optional aspects, the coherency state transition request may also include a request to mark the data in the I/O device cache 506 as invalid that may prompt the I/O device cache 506 to mark 606 the data in the cache as invalid. In various aspects, accesses to the I/O device cache 506 may be ordered using relaxed memory models for aspects including stale data. In various aspects, in the absence of a synchronization instruction for the I/O device cache 506, a quality of service for accessing the data stored in the I/O device cache 506 may be guaranteed.

The example illustrated in FIG. 6E represents processing a signal, following processing a look-ahead request that results in finding the requested data in the I/O device cache 506, as described with reference to FIG. 6A. In some aspects, the signal may be a forced invalidation for the I/O device cache 506 due to a synchronization instruction, following a coherency state transition request from the I/O device cache 506, as described with reference to FIG. 6D. In some aspects, the signal may be a coherency state transition request from the I/O device cache 506.

In various aspects, an I/O device, such as I/O device 514 in this example, may issue a synchronization command for the I/O device cache 506 to force synchronization of the data stored in the I/O device cache 506 with the data stored in other memory devices. The look-ahead device 508 may identify 630 when the synchronization command is issued for the I/O device cache 506.

In various aspects, in response to identifying 630 the synchronization command or in response to a coherency state transition request (e.g., the coherency state transition via the shared memory access request received 626 as described herein with reference to FIG. 6D), the look-ahead device 508 may check 602 whether the I/O device cache 506 contains the look-ahead requested data at the location in the I/O device cache 506 specified by the look-ahead request. In response to determining from the check 602 that the I/O device cache 506 contains the requested data at the location in the I/O device cache 506 specified by the look-ahead request, the look-ahead device 508 may retrieve 604 the requested data from the I/O device cache 506. In various aspects, the look-ahead device 508 may retrieve 604 the requested data by a request for the data from the I/O device cache 506 that may include a request to mark the data in the I/O device cache 506 as invalid. Responding to the data request of the look-ahead device 508 with the return data response may prompt the I/O device cache 506 to mark 606 the data in the cache as invalid or shared. After receiving the return data response from the I/O device cache 506, the look-ahead device 508 may store 608 the requested data to the look-ahead buffer 510.

The example illustrated in FIG. 6F represents processing a forced invalidation for the I/O device cache 506 due to a synchronization instruction, following processing a look-ahead request that results in finding the requested data in the I/O device cache 506, as described with reference to FIG. 6A, and a coherency state transition request from the I/O device cache 506, as described with reference to FIG. 6D. An I/O device, such as I/O device 514 in this example, may issue a synchronization command for the I/O device cache 506 to force synchronization of the data stored in the I/O device cache 506 with the data stored in other memory devices. The look-ahead device 508 may identify 630 when the synchronization command is issued for the I/O device cache 506. Another I/O device, in this example I/O device 502, may later send a cache access request to the I/O device cache 506. During transmission of the cache access request, the look-ahead device 508 may receive 610 the cache access request. In response to identifying 630 the synchronization instruction and later receiving 610 the cache access request, the look-ahead device may send 632 the cache access request to the I/O device cache 506. In various aspects, the look-ahead device 508 may send or forward the received cache access request by duplicating and sending the message signals of the cache access request. The I/O device cache 506 may respond to the cache access request by returning 634 the updated data stored in the I/O device cache 506. In various aspects, the return 634 of the requested data may be direct between the I/O device cache 506 and the I/O device 502 as the return 634 of the requested data may not affect anything for the look-ahead device 506. This direct return 634 may be possible because of the duplication of the messaging signals of the cache access request that may identify the I/O device 502 as the source of the cache access request. In various aspects, the return 634 of the requested data may be routed through the look-ahead device 508.

The example illustrated in FIG. 6G represents processing a cache access request, following processing a look-ahead request that results in finding the requested data in the I/O device cache 506, as described with reference to FIG. 6A, and a coherency state transition request from the I/O device cache 506. In various aspects, the look-ahead buffer 510 may store the address of the I/O device cache 506 for the data. In various aspects, the I/O device cache 506 may issue a coherency state transition request for itself at the same location in the I/O device cache 506 as the request data for the look-ahead request previously processed. The look-ahead device 508 may monitor 642 the I/O device cache 506 requesting data from the shared memory 504. The look-ahead device 508 may monitor 644 the shared memory 504 returning the requested data to the I/O device cache 506. The I/O device cache 506 may use the return data to update the data in the I/O device cache 506 at the location of the look-ahead request. In various optional aspects, in response to monitoring 642, 644 the signals between the I/O device cache 506 and the shared memory 504, the look-ahead device 508 may prompt the I/O device cache 506 to mark 606 the data in the cache as invalid.

The I/O device 502 may send a cache access request to the I/O device cache 506. During transmission of the cache access request, the look-ahead device 508 may receive 610 the cache access request. The look-ahead device 508 may check 646 whether the look-ahead buffer 510 contains the address of the I/O device cache 506 for the requested data specified in the cache access request. In response to determining from the check 646 that the address of the I/O device cache 506 for the requested data specified by the cache access request is stored in the look-ahead buffer 510, the look-ahead device 508 may send 622 the cache access request to the shared memory 504. Finding the address of the I/O device cache 506 for the requested data in the look-ahead buffer 510 may indicate that a copy of that data may be stored in the shared memory 504. In various aspects, the look-ahead device 508 may send or forward the received cache access request by duplicating and sending the message signals of the cache access request. In response to the cache access request, the cache access request may be sent to the shared memory 504 without snooping the I/O device cache 506 for the data specified by the cache access request. Skipping snooping the I/O device cache 506 and sending the cache access request to the shared memory 504 may reduce the time for multiple cache access requests by avoiding time used to snoop the I/O device cache 506 that results in a miss. The shared memory 504 may locate the requested data in the shared memory 504 and return 624 the requested data to the I/O device 502 that originally issued the cache access request. In various aspects, the return 624 of the requested data may be direct between the shared memory 504 and the I/O device 502 as the return 624 of the requested data does not affect anything for the look-ahead buffer 510. This direct return 624 of the requested data may be possible because of the duplication of the messaging signals of the cache access request that may identify the I/O device 502 as the source of the cache access request. In various aspects, the return 624 of the requested data may be routed through the look-ahead device 508.

The example illustrated in FIG. 6H represents processing a cache access request from an I/O device, in this example I/O device 636 (I/O device N), different from the I/O device that issued the look ahead request, such as I/O device 502 as in the example described with reference to FIG. 6A. The I/O device 636 may send a cache access request to the I/O device cache 506. During transmission of the cache access request, the look-ahead device 508 may receive 610 the cache access request. The look-ahead device 508 may check 612 whether the look-ahead buffer 510 contains the requested data specified in the cache access request. In response to determining from the check 612 that the requested data specified by the cache access request and the data stored in the look-ahead buffer 510 are the same, the look-ahead device 508 may retrieve 614 the requested data from the look-ahead buffer 510. While and/or after retrieving 614 the requested data from the look-ahead buffer 510, the look-ahead device 508 may return 616 the requested data to the I/O device 636 that sent the cache access request. The look-ahead device 506 may mark 620 or prompt 618 the look-ahead buffer 510 to mark 620 the requested data stored in the look-ahead buffer 510 as invalid. In various aspects, operations other than marking 610 the data invalid may be used to prevent use of the data stored in the look-ahead buffer 510, such as overwriting data in the look-ahead buffer 510 or deenergizing the look-ahead buffer 510 so that the data is not retained.

The example illustrated in FIG. 6I represents processing a look-ahead access request from an I/O device, in this example I/O device 636 (I/O device N), different from the I/O device that issued the look ahead request, such as I/O device 502 as in the example described with reference to FIG. 6A. The I/O device 636 may send a look-ahead request to the I/O device cache 506. During transmission of the look-ahead request, the look-ahead device 508 may receive 600 the look-ahead request. In response to receiving 600 the look-ahead request from the I/O device 636 after having received and processed the look-ahead request by the I/O device 502, the look-ahead device 508 may evict 638 or prompt the look-ahead buffer 510 to evict the look-ahead data stored in the look-ahead buffer 510 as a result of the look-ahead request by the I/O device 502. The look-ahead device 508 may retrieve 614 the evicted data from the look-ahead buffer 510, and send 640 the evicted data to the shared memory 504 for storage. Sending 640 the evicted data to the shared memory 504 may include sending a write command to the shared memory 504 for the evicted data. In various aspects, sending 640 the evicted data to the shared memory 504 for storage may be implemented for data marked as dirty, whereas clean data may not be required to update the data stored in the shared memory 504.

The example illustrated in FIG. 6J represents processing cache access request from an I/O device, in this example I/O device 636 (I/O device N), different from the I/O device that issued the look ahead-request, such as I/O device 502 as in the example described with reference to FIG. 6A, for the same data of the look-ahead request. The I/O device 636 may send a cache access request to the I/O device cache 506. During transmission of the cache access request, the look-ahead device 508 may receive 610 the cache access request. Since the look-ahead device 508 has not received a look-ahead request from the I/O device 636, the look-ahead device may send 632 the cache access request to the I/O device cache 506. The cache access request to the I/O device cache 506 may result in a miss, since the I/O device cache 506 may have previously returned and invalidated the data in response to an earlier look-ahead request. The I/O device cache 506 may respond to the miss by sending a shared memory access request to the shared memory 504 to retrieve the requested data of the cache access request. The look-ahead device 508 may receive 626 the shared memory access request, and may check 612 whether the look-ahead buffer 510 contains the requested data specified in the shared memory access request. The look-ahead device 508 may retrieve 614 the requested data from the look-ahead buffer 510. While and/or after retrieving 614 the requested data from the look-ahead buffer 510, the look-ahead device 508 may return 616 the requested data to the I/O device 636 that sent the cache access request. The look-ahead device 506 may mark 620 or prompt 618 the look-ahead buffer 510 to mark 620 the requested data stored in the look-ahead buffer 510 as invalid. In various aspects, operations other than marking 620 the data invalid may be used to prevent use of the data stored in the look-ahead buffer 510, such as overwriting data in the look-ahead buffer 510 or deenergizing the look-ahead buffer 510 so that the data is not retained.

The example illustrated in FIG. 6K represents processing cache access request from an I/O device, in this example I/O device 636 (I/O device N), different from the I/O device that issued the look ahead-request, such as I/O device 502 as in the example described with reference to FIG. 6A, for the same data of the look-ahead request following eviction of the data from the look-ahead buffer 510. The I/O device 636 may send a cache access request to the I/O device cache 506. During transmission of the cache access request, the look-ahead device 508 may receive 610 the cache access request. Since the look-ahead device 508 may have previously retrieved the data of the look-ahead request from the I/O device cache 506, the look-ahead device 508 may know that the locations for the data in the I/O device cache 506 were marked invalid or shared. Also, the look-ahead device 508 may know that the data requested by the look-ahead request may not be in the look-ahead buffer 510 due to eviction of the data. Knowing the requested data is not in the I/O device cache 506 and the look-ahead buffer 510, the look-ahead device 508 may send 622 the cache access request to the shared memory 504. The shared memory 504 may locate the requested data in the shared memory 504 and return 624 the requested data to the I/O device 636 that originally issued the cache access request.

The example illustrated in FIG. 6L represents processing an exclusive request to the look-ahead buffer 510, following processing a look-ahead request that results in finding the requested data in the I/O device cache 506, as described with reference to FIG. 6A. In various aspects, the look-ahead buffer 510 may be fully coherent. The I/O device cache 506 may issue an exclusive request for access to the look-ahead buffer 510. The exclusive request may include a write request to the look-ahead buffer 510 and an invalidate request for the look-ahead buffer. The write and invalidate requests may be for the same location in the look-ahead buffer 510. The look-ahead device 508 may receive 648 the exclusive request. The look-ahead device 508 may determine 650 whether an invalidate criterion is met. In various aspects, the invalidate criterion may include prior receipt of a cache access request for the data stored in the look-ahead buffer 510 at the same location as the location specified by the exclusive request, or whether a threshold, such as a designated period of time or a counter value, is reached. In response to determining that the invalidate criterion is met, the look-ahead device 506 may execute the exclusive request. As part of the execution of the exclusive request, the look-ahead device 506 may mark 620 or prompt 618 the look-ahead buffer 510 to mark 620 the requested data stored in the look-ahead buffer 510 as invalid.

The example illustrated in FIG. 6M represents processing an exclusive request to the look-ahead buffer 510, following processing a look-ahead request that results in finding the requested data in the I/O device cache 506, as described with reference to FIG. 6A. In various aspects, the look-ahead buffer 510 may be fully coherent. The I/O device cache 506 may issue an exclusive request for access to the look-ahead buffer 510. The look-ahead device 508 may receive 648 the exclusive request. The look-ahead device 508 may determine 650 whether an invalidate criterion is met. In response to determining that the invalidate criterion is not met, the look-ahead device 506 may queue 652 the exclusive request. The look-ahead device 508 may repeatedly determine 650 whether an invalidate criterion is met. In response to determining that the invalidate criterion is met, the look-ahead device 506 may remove 654 the exclusive request from the queue for execution. As part of the execution of the exclusive request, the look-ahead device 506 may mark 620 or prompt 618 the look-ahead buffer 510 to mark 620 the requested data stored in the look-ahead buffer 510 as invalid.

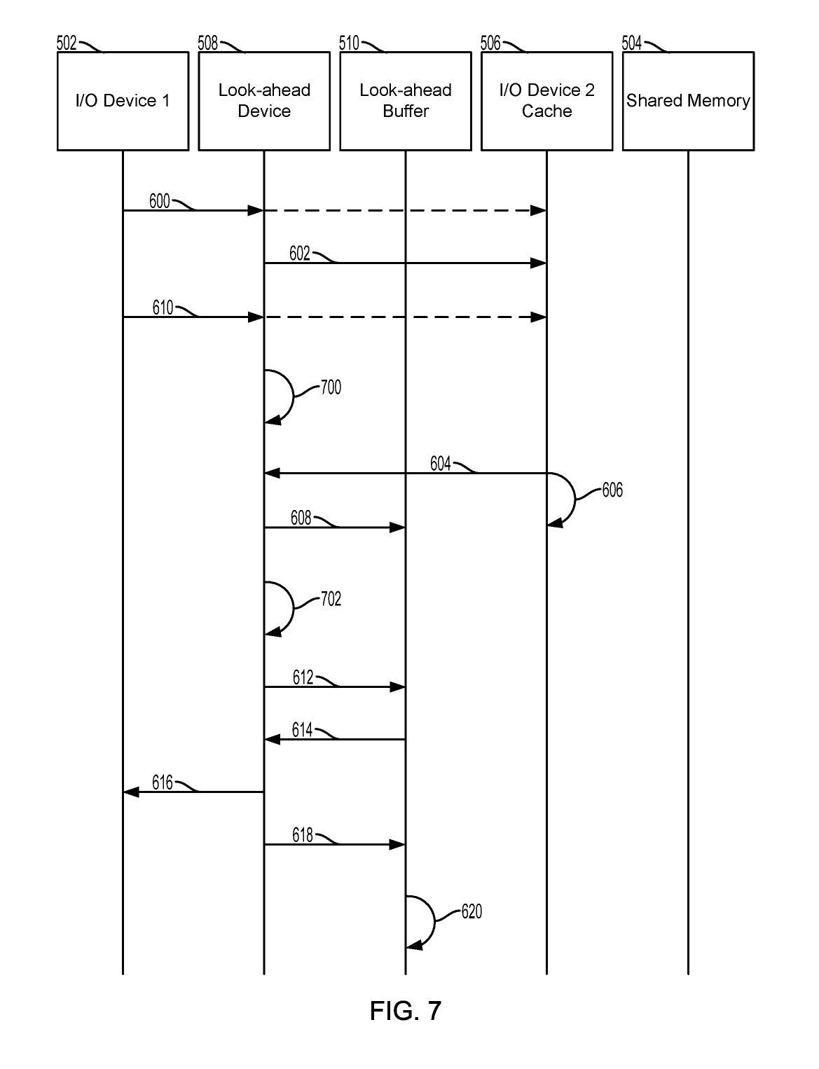

FIG. 7 illustrates an example of an operation flow for input/output-coherent look-ahead cache access using a look-ahead device implementing an aspect. The example illustrated in FIG. 7 relates to the structures of the components illustrated in FIGS. 1-7. The I/O device 502, 514, shared memory 504, I/O device cache 506, look-ahead device 508, and look-ahead device buffer 510 are used as examples for ease of explanation and brevity, but are not meant to limit the claims to the illustrated number and/or types of I/O devices (e.g., processor 14 in FIGS. 1-3, CPU cluster 406, GPU 410, DSP 412, 414, camera subsystem 418, video subsystem 420, display subsystem 422 in FIG. 4) or memory devices (e.g., memory 16, 24 in FIG. 1, dedicated cache memories 204, 206, 208, 210 and shared cache memories 212, 214 in FIGS. 2 and 3, system cache 402, and random access memory 428 in FIG. 4). Further, the order of the operations and signals 600-620, 700, and 702 is used as an example for ease of explanation and brevity, but is not meant to limit the claims to a particular order of execution of the operations and signals 600-620, 700, and 702 as several of the operations and signals 600-620, 700, and 702 may be implemented in parallel and in other orders.

The example illustrated in FIG. 7 represents processing a look-ahead request and a cache access request that is received prior to completion of processing the look-ahead request. The I/O device 502 may send a look-ahead request to the I/O device cache 506. During transmission of the look-ahead request, the look-ahead device 508 may receive 600 the look-ahead request. The look-ahead device 508 may check 602 whether the I/O device cache 506 contains the requested data at the location in the I/O device cache 506 specified by the look-ahead request.

The I/O device 502 may send a cache access request to the I/O device cache 506. During transmission of the cache access request, the look-ahead device 508 may receive 610 the cache access request. The cache access request may be received 610 at any time before the look-ahead device 508 stores the requested data of the look-ahead request to the look-ahead buffer 510. In response to receiving 610 the cache access request during processing of a look-ahead request, the look-ahead device 508 may queue 700 the cache access request for processing after processing of the look-ahead request is complete.

In response to determining from the check 602 that the I/O device cache 506 contains the requested data at the location in the I/O device cache 506 specified by the look-ahead request, the look-ahead device 508 may retrieve 604 the requested data from the I/O device cache 506. In various aspects, the look-ahead device 508 may retrieve 604 the requested data by a request for the data from the I/O device cache 506 that may include a request to mark the data in the I/O device cache 506 as invalid. Responding to the data request of the look-ahead device 508 with the return data response may prompt the I/O device cache 506 to mark 606 the data in the cache as invalid or shared. After receiving the return data response from the I/O device cache 506, the look-ahead device 508 may store 608 the requested data to the look-ahead buffer 510.

Since the look-ahead request processing is complete, the look-ahead device 508 may retrieve 702 the cache access request from a queue and process the cache access request. The look-ahead device 508 may check 612 whether the look-ahead buffer 510 contains the requested data specified in the cache access request. In response to determining from the check 612 that the requested data specified by the cache access request and the data stored in the look-ahead buffer 510 are the same, the look-ahead device 508 may retrieve 614 the requested data from the look-ahead buffer 510. While and/or after retrieving 614 the requested data from the look-ahead buffer 510, the look-ahead device 508 may return 616 the requested data to the I/O device 502 that sent the cache access request. The look-ahead device 506 may mark 620 or prompt 618 the look-ahead buffer 510 to mark 620 the requested data stored in the look-ahead buffer 510 as invalid. In various aspects, operations other than marking 620 the data invalid may be used to prevent use of the data stored in the look-ahead buffer 510, such as overwriting data in the look-ahead buffer 510 or deenergizing the look-ahead buffer 510 so that the data is not retained.

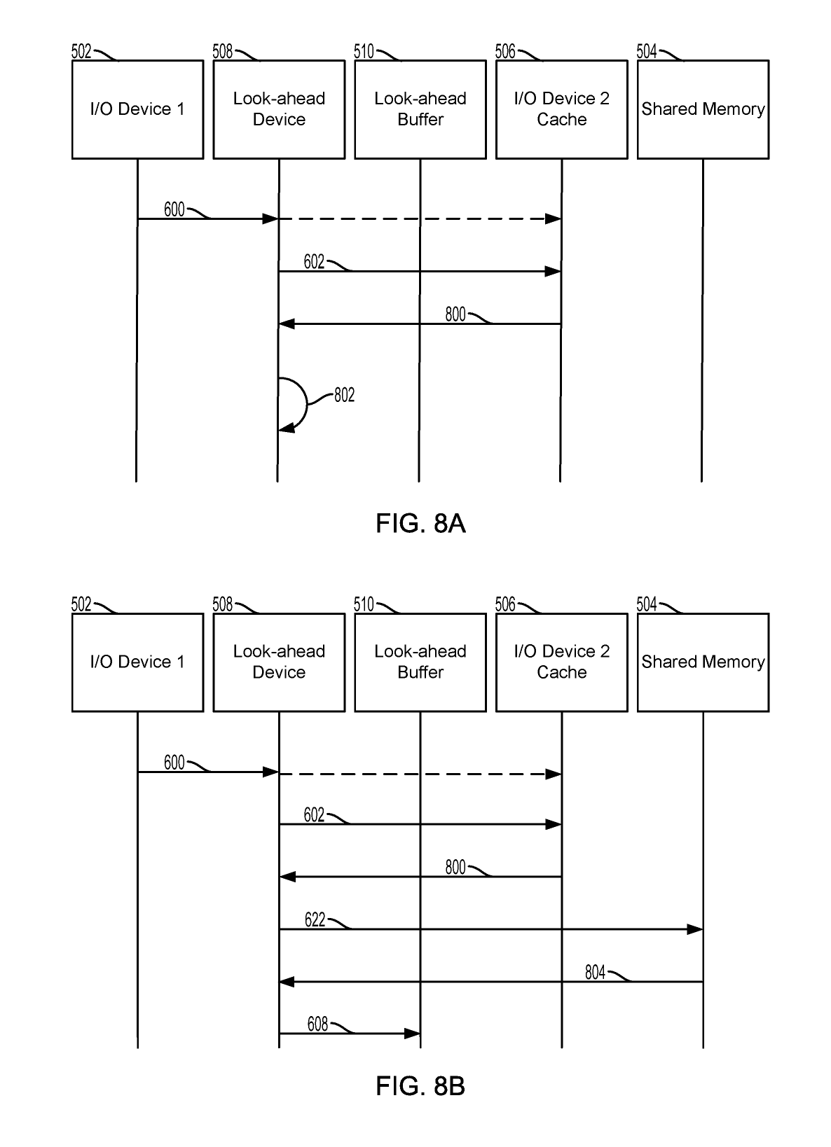

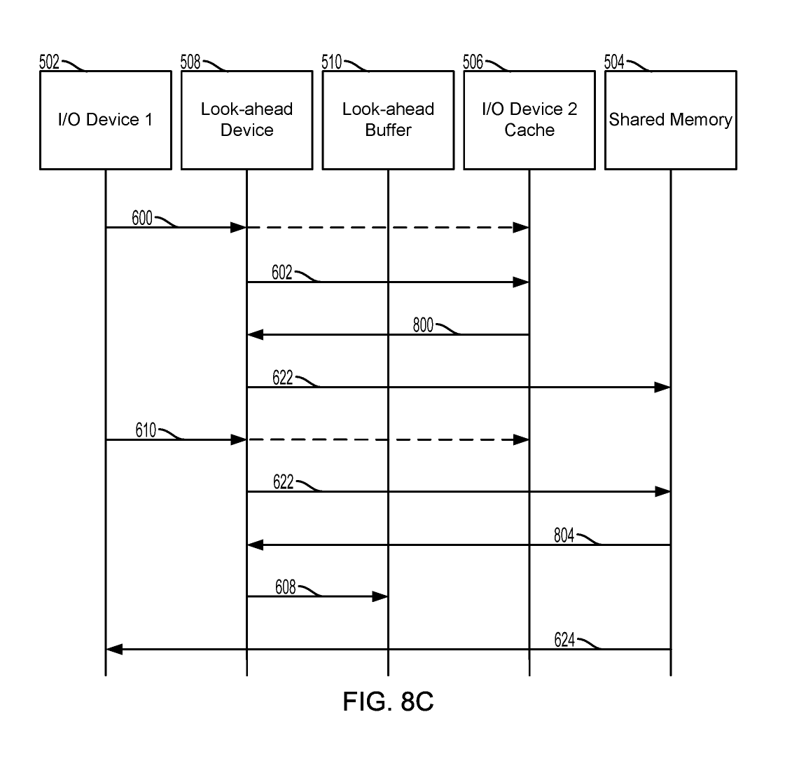

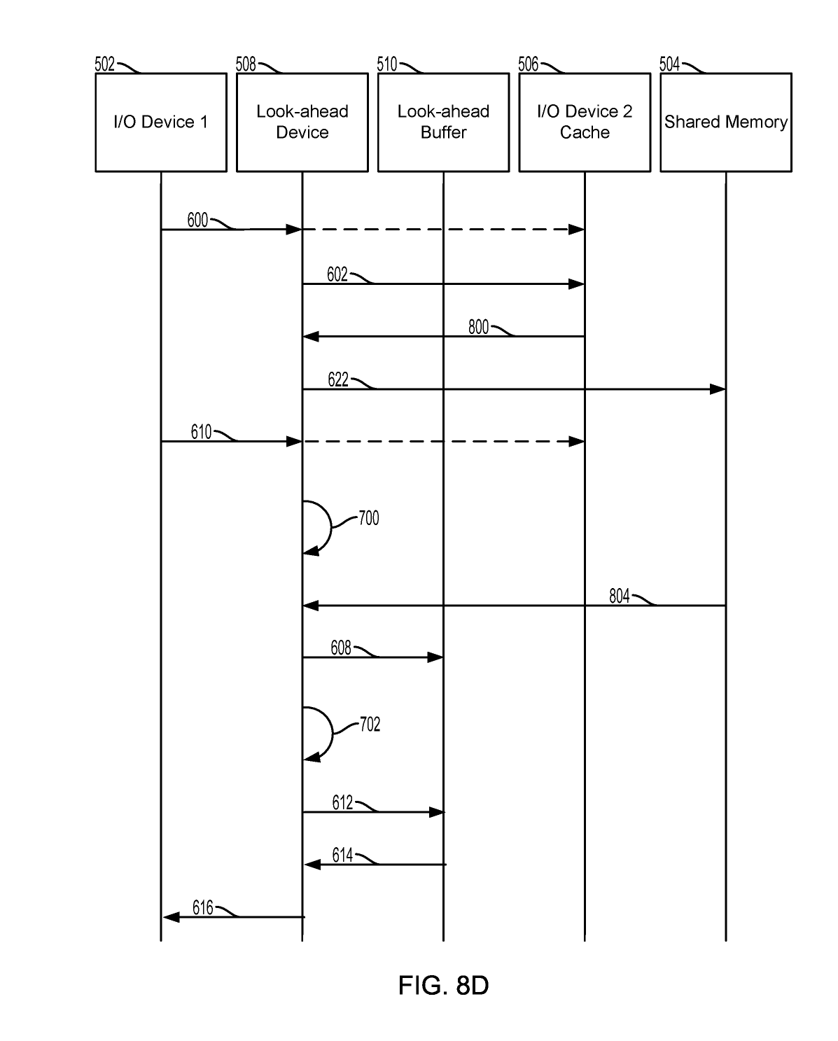

FIGS. 8A-8D illustrate examples of operation flows for input/output-coherent look-ahead cache access using a look-ahead device implementing an aspect in which the I/O device cache 506 may be configured as a client only cache. In other words, the I/O device cache 506 may not be configured to generate shared memory access requests in response to a miss in the I/O device cache 506. The examples illustrated in FIGS. 8A-8D relate to the structures of the components illustrated in FIGS. 1-8. The I/O device 502, 514, shared memory 504, I/O device cache 506, look-ahead device 508, and look-ahead device buffer 510 are used as examples for ease of explanation and brevity, but are not meant to limit the claims to the illustrated number and/or types of I/O devices (e.g., processor 14 in FIGS. 1-3, CPU cluster 406, GPU 410, DSP 412, 414, camera subsystem 418, video subsystem 420, display subsystem 422 in FIG. 4) or memory devices (e.g., memory 16, 24 in FIG. 1, dedicated cache memories 204, 206, 208, 210 and shared cache memories 212, 214 in FIGS. 2 and 3, system cache 402, and random access memory 428 in FIG. 4). Further, the order of the operations and signals 600, 602, 608-616, 622, 624,700, 702, and 800-804 is used as an example for ease of explanation and brevity, but is not meant to limit the claims to a particular order of execution of the operations and signals 600, 602, 608-616, 622, 624,700, 702, and 800-804 as several of the operations and signals 600, 602, 608-616, 622, 624,700, 702, and 800-804 may be implemented in parallel and in other orders.

The example illustrated in FIG. 8A represents processing a look-ahead request that results in not finding the requested data in the I/O device cache 506 (sometimes referred to as a “miss”). The I/O device 502 may send a look-ahead request to the I/O device cache 506. During transmission of the look-ahead request, the look-ahead device 508 may receive 600 the look-ahead request. The look-ahead device 508 may check 602 whether the I/O device cache 506 contains the requested data at the location in the I/O device cache 506 specified by the look-ahead request. In response to determining from the check 602 that the I/O device cache 506 does not contain the requested data at the location in the I/O device cache 506 specified by the look-ahead request, the look-ahead cache 506 may respond 800 to the look-ahead device 508 with an indication that the requested data is not found. The look-ahead device 508 may respond to the failure to find the requested data in the I/O device cache 506 by dropping 802 the look-ahead request.

The example illustrated in FIG. 8B represents processing a look-ahead request that results in not finding the requested data in the I/O device cache 506. The I/O device 502 may send a look-ahead request to the I/O device cache 506. During transmission of the look-ahead request, the look-ahead device 508 may receive 600 the look-ahead request. The look-ahead device 508 may check 602 whether the I/O device cache 506 contains the requested data at the location in the I/O device cache 506 specified by the look-ahead request. In response to determining from the check 602 that the I/O device cache 506 does not contain the requested data at the location in the I/O device cache 506 specified by the look-ahead request, the look-ahead cache 506 may respond 800 to the look-ahead device 508 with an indication that the requested data is not found. The look-ahead device 508 may respond to the failure to find the requested data in the I/O device cache 506 by sending 622 the look-ahead request to the shared memory 504. The shared memory 504 may locate the requested data in the shared memory 504 and return 804 the requested data to the look-ahead device 508. After receiving the return data response from the shared memory 504, the look-ahead device 508 may store 608 the requested data to the look-ahead buffer 510.

The example illustrated in FIG. 8C represents processing a look-ahead request and a cache access request that is received prior to completion of processing the look-ahead request. The I/O device 502 may send a look-ahead request to the I/O device cache 506. During transmission of the look-ahead request, the look-ahead device 508 may receive 600 the look-ahead request. The look-ahead device 508 may check 602 whether the I/O device cache 506 contains the requested data at the location in the I/O device cache 506 specified by the look-ahead request. In response to determining from the check 602 that the I/O device cache 506 does not contain the requested data at the location in the I/O device cache 506 specified by the look-ahead request, the look-ahead device cache 506 may respond 800 to the look-ahead device 508 with an indication that the requested data is not found. The look-ahead device 508 may respond to the failure to find the requested data in the I/O device cache 506 by sending 622 the look-ahead request to the shared memory 504.

The I/O device 502 may send a cache access request to the I/O device cache 506. During transmission of the cache access request, the look-ahead device 508 may receive 610 the cache access request. The cache access request may be received 610 at any time before the look-ahead device 508 stores the requested data of the look-ahead request to the look-ahead buffer 510. In response to receiving 610 the cache access request during processing of a look-ahead request, having not completed the processing of the current look-ahead request, the look-ahead device 508 may send 622 the cache access request to the shared memory 504.

The shared memory 504 may locate the requested data of the look-ahead request in the shared memory 504 and return 804 the requested data to the look-ahead device 508. After receiving the return data response from the shared memory 504, the look-ahead device 508 may store 608 the requested data to the look-ahead buffer 510.

The shared memory 504 may locate the requested data of the cache access request in the shared memory 504 and return 624 the requested data to the I/O device 636 that originally issued the cache access request.

The example illustrated in FIG. 8D represents processing a look-ahead request and a cache access request that is received prior to completion of processing the look-ahead request. The I/O device 502 may send a look-ahead request to the I/O device cache 506. During transmission of the look-ahead request, the look-ahead device 508 may receive 600 the look-ahead request. The look-ahead device 508 may check 602 whether the I/O device cache 506 contains the requested data at the location in the I/O device cache 506 specified by the look-ahead request. In response to determining from the check 602 that the I/O device cache 506 does not contain the requested data at the location in the I/O device cache 506 specified by the look-ahead request, the look-ahead cache 506 may respond 800 to the look-ahead device 508 with an indication that the requested data is not found. The look-ahead device 508 may respond to the failure to find the requested data in the I/O device cache 506 by sending 622 the look-ahead request to the shared memory 504.

The I/O device 502 may send a cache access request to the I/O device cache 506. During transmission of the cache access request, the look-ahead device 508 may receive 610 the cache access request. The cache access request may be received 610 at any time before the look-ahead device 508 stores the requested data of the look-ahead request to the look-ahead buffer 510. In response to receiving 610 the cache access request during processing of a look-ahead request, the look-ahead device 508 may queue 700 the cache access request for processing after processing of the look-ahead request is complete.

The shared memory 504 may locate the requested data of the look-ahead request in the shared memory 504 and return 804 the requested data to the look-ahead device 508. After receiving the return data response from the shared memory 504, the look-ahead device 508 may store 608 the requested data to the look-ahead buffer 510.

Since the look-ahead request processing is complete, the look-ahead device 508 may retrieve 702 the cache access request from a queue and process the cache access request. The look-ahead device 508 may check 612 whether the look-ahead buffer 510 contains the requested data specified in the cache access request. In response to determining from the check 612 that the requested data specified by the cache access request and the data stored in the look-ahead buffer 510 are the same, the look-ahead device 508 may retrieve 614 the requested data from the look-ahead buffer 510. While and/or after retrieving 614 the requested data from the look-ahead buffer 510, the look-ahead device 508 may return 616 the requested data to the I/O device 502 that sent the cache access request.

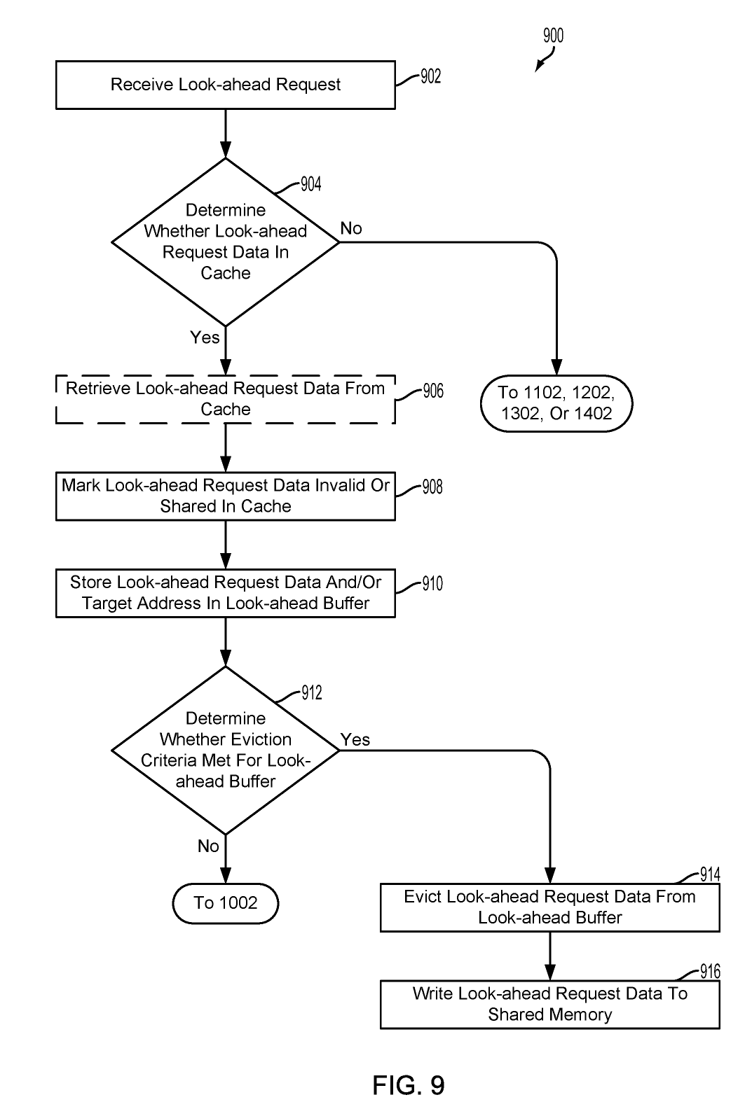

FIG. 9 illustrates a method 900 for implementing input/output-coherent look-ahead cache access according to an aspect. The method 900 may be implemented in a computing device in software executing in a processor (e.g., processor 14 in FIGS. 1-3, CPU cluster 406, GPU 410, DSP 412, 414, camera subsystem 418, video subsystem 420, display subsystem 422 in FIG. 4, I/O device 502, 514 in FIGS. 5-8D), in general purpose hardware, in dedicated hardware (e.g., look-ahead device 508 in FIGS. 5-8D), or in a combination of a software-configured processor and dedicated hardware, such as a processor executing software within a memory management system that includes other individual components (e.g., memory 16, 24 in FIG. 1, dedicated cache memories 204, 206, 208, 210 and shared cache memories 212, 214 in FIGS. 2 and 3, system cache 402, random access memory 428 in FIG. 4, shared memory 504, look-ahead device buffer 510 in FIGS. 5-8D, and various memory/cache controllers). In order to encompass the alternative configurations enabled in the various aspects, the hardware implementing the method 900 is referred to herein as a “processing device.” Further, portions of the methods 900, 1000, 1100, 1200, 1300, 1400, 1500, 1600, 1700, 1800, 1900, and 2000 in FIGS. 9-20 may be implemented in response to and parallel with each other.

In block 902, the processing device may receive a look-ahead request. In various aspects, the look-ahead request may be directed to a device other than the processing device, such as a cache. The processing device may be communicatively connected to a communication bus, such as an interconnect bus, and the processing device may receive or intercept the look-ahead request along the communication path to the cache. As previously noted, the terms receive and intercept are used interchangeably in the context of receiving or intercepting the look-ahead request.

In determination block 904, the processing device may determine whether the look-ahead request data is stored in the cache. In various aspects, determining whether specific data is stored in the cache may include using information included in the look-ahead request, such as a target address in the cache, to check whether the data is stored at a location in the cache derived from the look-ahead request information. Checking for data in the cache may include a process known as snooping, and as previously noted, the terms checking and snooping are used interchangeably in the context of checking for data stored in a memory device, such as the cache.

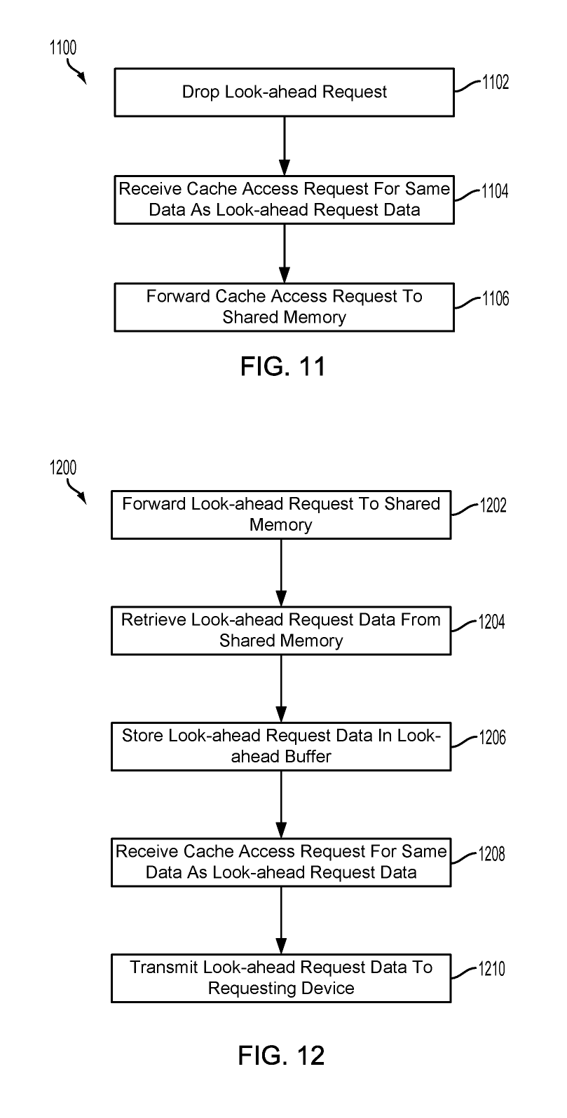

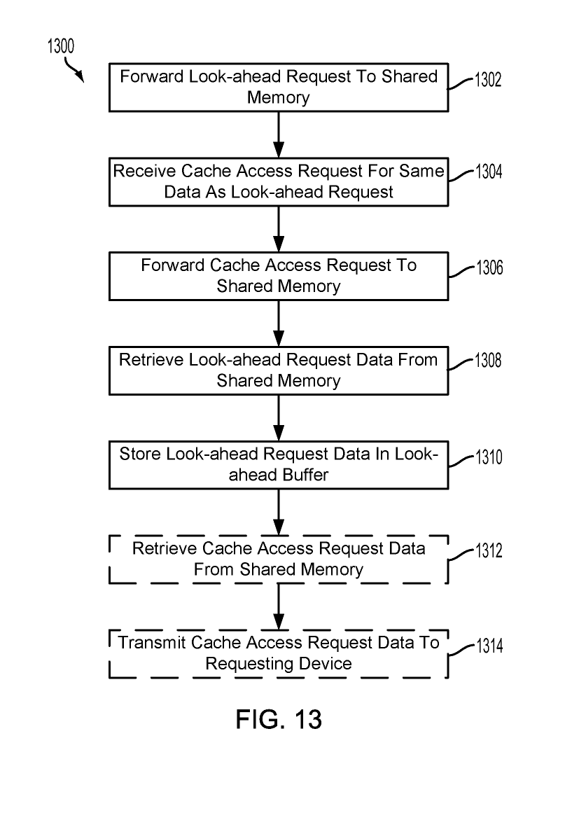

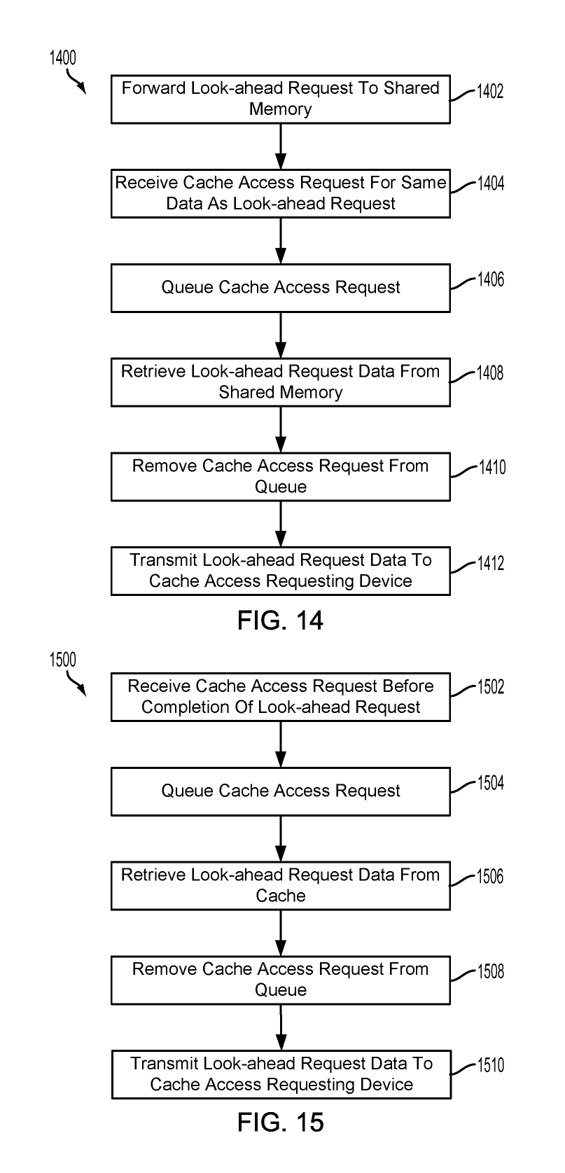

In response to determining that the look-ahead request data is not stored in the cache (i.e., determination block 904=“No”), the processing device may execute various functions, such as the functions described with reference to block 1102 of the method 1100 in FIG. 11, block 1202 of the method 1200 in FIG. 12, block 1302 of the method 1300 in FIG. 13, and/or block 1402 of the method 1400 in FIG. 14, depending on various configurations of the processing device.

In various aspects, in response to determining that the look-ahead request data is stored in the cache (i.e., determination block 904=“Yes”), the processing device may retrieve the look-ahead request data from the cache in optional block 906. In various aspects, the processing device may retrieve data from the cache by sending a read request, prompting the cache to return specific data in response to the request, or an exclusive read request, which, in addition to the functions and responses of the read request, may prompt the cache to mark locations of the data returned in response to the read request as invalid or shared in block 908. In various aspects, in response to determining that the look-ahead request data is stored in the cache (i.e., determination block 904=“Yes”), the processing device may prompt the cache to mark locations of the look-ahead request data as invalid or shared in block 908.

In block 910, the processing device may store the returned look-ahead request data and/or the target address in the cache of the cache access request in a memory device, such as a buffer or cache associated with the processing device. In various aspects, the memory device may be fully coherent. In various aspects, data stored in the memory device may include the look-ahead request data retrieved from the cache and/or the target address in the cache of the cache access request.

In determination block 912, the processing device may determine whether an eviction criteria for the data stored in the memory device is met. In various aspects, any number of eviction criteria may be used for determining whether to evict data stored in the memory device, such as receipt of another look-ahead request, retrieval of the data in response to a cache access request, and/or any time, resource availability, and/or performance based criteria.

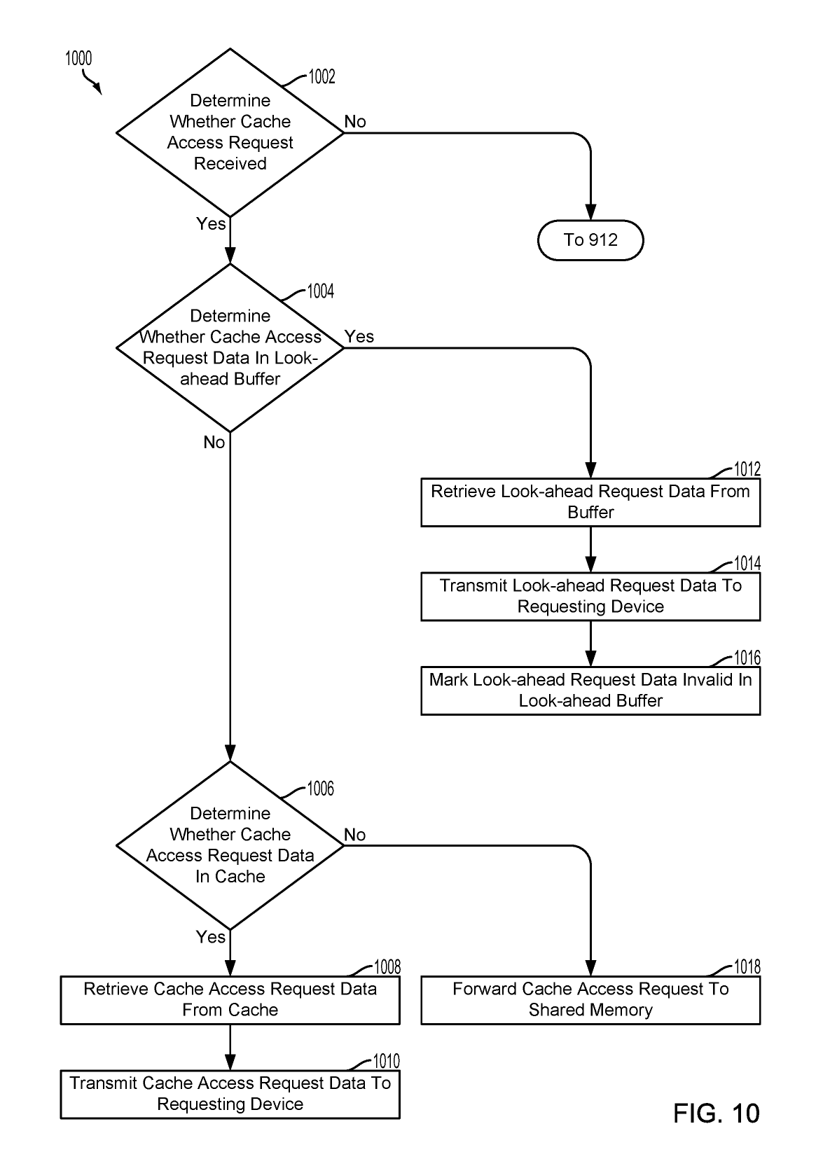

In response to determining that the eviction criteria for the data stored in the memory device is not met (i.e., determination block 912=“No”), the processing device may execute functions described with reference to block 1002 of the method 1000 in FIG. 10.

In response to determining that the eviction criteria for the data stored in the memory device is met (i.e., determination block 912=“Yes”), the processing device may evict the look-ahead request data from the memory device in block 914. In various aspects, evicting the look-ahead request data may include reading out the look-ahead request data from the memory device and marking locations of the look-ahead request data from in the memory device as invalid, overwriting the look-ahead request data, and/or removing power to the memory device to allow energy storage components of the memory device to deenergize and lose the look-ahead request data represented by the energized components.

In block 916, the processing device may write the look-ahead request data to a memory device, such as a shared memory. The processing device may not have direct access to the shared memory and may send a write request to a shared memory manager to write the look-ahead request data to the shared memory. In various aspects, reading out the evicted data in block 914 and writing the evicted data in block 916 may be implemented for data marked as dirty, whereas clean data may not be required to update the data stored in the memory device.

FIG. 10 illustrates a method 1000 for implementing input/output-coherent look-ahead cache access according to an aspect. The method 1000 may be implemented in a computing device in software executing in a processor (e.g., processor 14 in FIGS. 1-3, CPU cluster 406, GPU 410, DSP 412, 414, camera subsystem 418, video subsystem 420, display subsystem 422 in FIG. 4, I/O device 502, 514 in FIGS. 5-8D), in general purpose hardware, in dedicated hardware (e.g., look-ahead device 508 in FIGS. 5-8D), or in a combination of a software-configured processor and dedicated hardware, such as a processor executing software within a memory management system that includes other individual components (e.g., memory 16, 24 in FIG. 1, dedicated cache memories 204, 206, 208, 210 and shared cache memories 212, 214 in FIGS. 2 and 3, system cache 402, random access memory 428 in FIG. 4, shared memory 504, look-ahead device buffer 510 in FIGS. 5-8D, and various memory/cache controllers). In order to encompass the alternative configurations enabled in the various aspects, the hardware implementing the method 1000 is referred to herein as a “processing device.” Further, portions of the methods 900, 1000, 1100, 1200, 1300, 1400, 1500, 1600, 1700, 1800, 1900, and 2000 in FIGS. 9-20 may be implemented in response to and parallel with each other.

In determination block 1002, the processing device may determine whether a cache access request is received. In various aspects, the cache access request may be directed to a device other than the processing device, such as a cache. The processing device may be communicatively connected to a communication bus, such as an interconnect bus, and the processing device may receive or intercept the cache access request along the communication path to the cache.

In response to determining that the cache access request is not received (i.e., determination block 1002=“No”), the processing device may execute functions described with reference to block 912 of the method 900 in FIG. 9.

In response to determining that the cache access request is received (i.e., determination block 1002=“Yes”), the processing device may determine whether data requested by the cache access request is stored in a memory device, such as a buffer associated with the processing device, in determination block 1004.

In response to determining that the cache access request data is stored in the memory device (i.e., determination block 1004=“Yes”), the processing device may retrieve the look-ahead request data from the memory device in block 1012.

In block 1014, the processing device may transmit the look-ahead request data, matching the cache access request data, to the device, such as an I/O device, that sent the cache access request received by the processing device. The transmission of the look-ahead request data may be configured as a response with return data to the cache access request.

In block 1016, the processing device may mark locations of the look-ahead request data from in the memory device as invalid. Marking the location invalid may be implemented in a similar manner to when evicting the look-ahead request data from the memory device as described with reference to block 914 of the method 900 in FIG. 9, including options to overwrite the data and/or deenergize the memory device.

In response to determining that the cache access request data is not stored in the memory device (i.e., determination block 1004=“No”), the processing device may determine whether the cache access request data is stored in the cache in determination block 1006. In various aspects, determining whether the cache access request data is stored in the cache may be implemented in a similar manner to determining whether the look-ahead request data is stored in the cache described with reference to block 904 of the method 900 in FIG. 9; differing in that the information from the cache access request indicating the location of the data in the cache may be used rather than the information from the look-ahead request.

In response to determining that the cache access request data is not stored in the cache (i.e., determination block 1006=“No”), the processing device may send the cache access request to a memory device, such as a shared memory in block 1018. In various aspects, sending or forwarding the received cache access request may be accomplished by duplicating and sending message signals of the cache access request.

In response to determining that the cache access request data is stored in the cache (i.e., determination block 1006=“Yes”), the processing device may retrieve the cache access request data from the cache in block 1008. In various aspects, the processing device may retrieve data from the cache by sending a read request, prompting the cache to return specific data in response to the request.

In block 1010, the processing device may transmit the cache access request data to the device, such as an I/O device, that sent the cache access request received by the processing device. The transmission of the cache access request data may be configured as a response with return data to the cache access request.

FIG. 11 illustrates a method 1100 for implementing input/output-coherent look-ahead cache access according to an aspect. The method 1100 may be implemented in a computing device in software executing in a processor (e.g., processor 14 in FIGS. 1-3, CPU cluster 406, GPU 410, DSP 412, 414, camera subsystem 418, video subsystem 420, display subsystem 422 in FIG. 4, I/O device 502, 514 in FIGS. 5-8D), in general purpose hardware, in dedicated hardware (e.g., look-ahead device 508 in FIGS. 5-8D), or in a combination of a software-configured processor and dedicated hardware, such as a processor executing software within a memory management system that includes other individual components (e.g., memory 16, 24 in FIG. 1, dedicated cache memories 204, 206, 208, 210 and shared cache memories 212, 214 in FIGS. 2 and 3, system cache 402, random access memory 428 in FIG. 4, shared memory 504, look-ahead device buffer 510 in FIGS. 5-8D, and various memory/cache controllers). In order to encompass the alternative configurations enabled in the various aspects, the hardware implementing the method 1100 is referred to herein as a “processing device.” Further, portions of the methods 900, 1000, 1100, 1200, 1300, 1400, 1500, 1600, 1700, 1800, 1900, and 2000 in FIGS. 9-20 may be implemented in response to and parallel with each other.

In response to determining that the look-ahead request data is not stored in the cache (i.e., determination block 904 of the method 900 in FIG. 9=“No”), the processing device may the drop look-ahead request in block 1102. Dropping the look-ahead request may include no further processing the look-ahead request so that no inquiries are made to other memory devices, such as a cache or a shared memory are made for the look-ahead request data.

In block 1104, the processing device may receive a cache access request. As previously noted, the terms receive and intercept are used interchangeably in the context of receiving or intercepting the cache access request. The cache access request may include a request for the same data as the dropped look-ahead request.

In block 1106, the processing device may send the cache access request to a memory device, such as a shared memory. In various aspects, sending or forwarding the received cache access request may be accomplished by duplicating and sending message signals of the cache access request. Once forwarded to the shared memory, the cache access may be processed as a cache access that resulted in a miss in the cache.

FIG. 12 illustrates a method 1200 for implementing input/output-coherent look-ahead cache access according to an aspect. The method 1200 may be implemented in a computing device in software executing in a processor (e.g., processor 14 in FIGS. 1-3, CPU cluster 406, GPU 410, DSP 412, 414, camera subsystem 418, video subsystem 420, display subsystem 422 in FIG. 4, I/O device 502, 514 in FIGS. 5-8D), in general purpose hardware, in dedicated hardware (e.g., look-ahead device 508 in FIGS. 5-8D), or in a combination of a software-configured processor and dedicated hardware, such as a processor executing software within a memory management system that includes other individual components (e.g., memory 16, 24 in FIG. 1, dedicated cache memories 204, 206, 208, 210 and shared cache memories 212, 214 in FIGS. 2 and 3, system cache 402, random access memory 428 in FIG. 4, shared memory 504, look-ahead device buffer 510 in FIGS. 5-8D, and various memory/cache controllers). In order to encompass the alternative configurations enabled in the various aspects, the hardware implementing the method 1200 is referred to herein as a “processing device.” Further, portions of the methods 900, 1000, 1100, 1200, 1300, 1400, 1500, 1600, 1700, 1800, 1900, and 2000 in FIGS. 9-20 may be implemented in response to and parallel with each other.

In response to determining that the look-ahead request data is not stored in the cache (i.e., determination block 904 of the method 900 in FIG. 9=“No”), the processing device may send the look-ahead request to a memory device, such as a shared memory in block 1202. In various aspects, sending or forwarding the received look-ahead request may be accomplished by duplicating and sending message signals of the look-ahead request.

In block 1204, the processing device may retrieve the look-ahead request data from the shared memory.

In block 1206, the processing device may store the returned look-ahead request data in a memory device, such as a buffer, associated with the processing device.

In block 1208, the processing device may receive a cache access request. The cache access request may include a request for the same data as the look-ahead request.

In block 1210, the processing device may transmit the look-ahead request data, matching the cache access request data, to the device, such as an I/O device, that sent the cache access request received by the processing device in block 1208. The transmission of the look-ahead request data may be configured as a response with return data to the cache access request.

FIG. 13 illustrates a method 1300 for implementing input/output-coherent look-ahead cache access according to an aspect. The method 1300 may be implemented in a computing device in software executing in a processor (e.g., processor 14 in FIGS. 1-3, CPU cluster 406, GPU 410, DSP 412, 414, camera subsystem 418, video subsystem 420, display subsystem 422 in FIG. 4, I/O device 502, 514 in FIGS. 5-8D), in general purpose hardware, in dedicated hardware (e.g., look-ahead device 508 in FIGS. 5-8D), or in a combination of a software-configured processor and dedicated hardware, such as a processor executing software within a memory management system that includes other individual components (e.g., memory 16, 24 in FIG. 1, dedicated cache memories 204, 206, 208, 210 and shared cache memories 212, 214 in FIGS. 2 and 3, system cache 402, random access memory 428 in FIG. 4, shared memory 504, look-ahead device buffer 510 in FIGS. 5-8D, and various memory/cache controllers). In order to encompass the alternative configurations enabled in the various aspects, the hardware implementing the method 1300 is referred to herein as a “processing device.” Further, portions of the methods 900, 1000, 1100, 1200, 1300, 1400, 1500, 1600, 1700, 1800, 1900, and 2000 in FIGS. 9-20 may be implemented in response to and parallel with each other.

In response to determining that the look-ahead request data is not stored in the cache (i.e., determination block 904 of the method 900 in FIG. 9=“No”), the processing device may send the look-ahead request to a memory device, such as a shared memory in block 1302. In various aspects, sending or forwarding the received look-ahead request may be accomplished by duplicating and sending message signals of the look-ahead request.

In block 1304, the processing device may receive a cache access request. The cache access request may include a request for the same data as the look-ahead request and may be received prior to completion of the look-ahead request, which is sent to the memory device in block 1302.

In block 1306, the processing device may send the cache access request to a memory device, such as a shared memory. In various aspects, sending or forwarding the received cache access request may be accomplished by duplicating and sending message signals of the cache access request.

In block 1308, the processing device may retrieve the look-ahead request data from the shared memory.

In block 1310, the processing device may store the returned look-ahead request data in a memory device, such as a buffer, associated with the processing device.

In optional block 1312, the processing device may retrieve the cache access request data from the shared memory.

In optional block 1314, the processing device may transmit the cache access request data to the device, such as an I/O device, that sent the cache access request received by the processing device. The transmission of the cache access request data may be configured as a response with return data to the cache access request.

In various aspects, the cache access request data may be returned from the memory device to the device, such as an I/O device, that sent the cache access request received by the processing device by passing the processing device.

FIG. 14 illustrates a method 1400 for implementing input/output-coherent look-ahead cache access according to an aspect. The method 1400 may be implemented in a computing device in software executing in a processor (e.g., processor 14 in FIGS. 1-3, CPU cluster 406, GPU 410, DSP 412, 414, camera subsystem 418, video subsystem 420, display subsystem 422 in FIG. 4, I/O device 502, 514 in FIGS. 5-8D), in general purpose hardware, in dedicated hardware (e.g., look-ahead device 508 in FIGS. 5-8D), or in a combination of a software-configured processor and dedicated hardware, such as a processor executing software within a memory management system that includes other individual components (e.g., memory 16, 24 in FIG. 1, dedicated cache memories 204, 206, 208, 210 and shared cache memories 212, 214 in FIGS. 2 and 3, system cache 402, random access memory 428 in FIG. 4, shared memory 504, look-ahead device buffer 510 in FIGS. 5-8D, and various memory/cache controllers).

In order to encompass the alternative configurations enabled in the various aspects, the hardware implementing the method 1400 is referred to herein as a “processing device.” Further, portions of the methods 900, 1000, 1100, 1200, 1300, 1400, 1500, 1600, 1700, 1800, 1900, and 2000 in FIGS. 9-20 may be implemented in response to and parallel with each other.

In response to determining that the look-ahead request data is not stored in the cache (i.e., determination block 904 of the method 900 in FIG. 9=“No”), the processing device may send the look-ahead request to a memory device, such as a shared memory in block 1402. In various aspects, sending or forwarding the received look-ahead request may be accomplished by duplicating and sending message signals of the look-ahead request.

In block 1404, the processing device may receive a cache access request. The cache access request may include a request for the same data as the look-ahead request.

In block 1406, the processing device may queue the cache access request. In various aspects, the queue may be implemented using various techniques and may be configured to queue any number of cache access requests. The queue may be sized to hold a number of cache access requests that may be related to a number of active and/or pending look-ahead requests. The order in which cache access requests in the queue may be services may be based on a first-in first-out order and/or an on-demand order so that cache access requests for the same data as a completed look-ahead request may be removed from the queue and processed based on the order of availability of the data.

In block 1408, the processing device may retrieve the look-ahead request data from the shared memory.

In block 1410, the processing device may remove the cache access request from the queue for processing the look-ahead request. In block 1412, the processing device may transmit the cache access request data to the device, such as an I/O device, that sent the cache access request received by the processing device. The transmission of the look-ahead request data may be configured as a response with return data to the cache access request.

FIG. 15 illustrates a method 1500 for implementing input/output-coherent look-ahead cache access according to an aspect. The method 1500 may be implemented in a computing device in software executing in a processor (e.g., processor 14 in FIGS. 1-3, CPU cluster 406, GPU 410, DSP 412, 414, camera subsystem 418, video subsystem 420, display subsystem 422 in FIG. 4, I/O device 502, 514 in FIGS. 5-8D), in general purpose hardware, in dedicated hardware (e.g., look-ahead device 508 in FIGS. 5-8D), or in a combination of a software-configured processor and dedicated hardware, such as a processor executing software within a memory management system that includes other individual components (e.g., memory 16, 24 in FIG. 1, dedicated cache memories 204, 206, 208, 210 and shared cache memories 212, 214 in FIGS. 2 and 3, system cache 402, random access memory 428 in FIG. 4, shared memory 504, look-ahead device buffer 510 in FIGS. 5-8D, and various memory/cache controllers). In order to encompass the alternative configurations enabled in the various aspects, the hardware implementing the method 1500 is referred to herein as a “processing device.” Further, portions of the methods 900, 1000, 1100, 1200, 1300, 1400, 1500, 1600, 1700, 1800, 1900, and 2000 in FIGS. 9-20 may be implemented in response to and parallel with each other.

In various aspects, the method 1500 may begin execution any time after receiving a look-ahead request, such as in block 902, and before completing processing the look-ahead request by storing the look-ahead request data to a memory device, such as in block 910, block 1206, and/or block 1310, or retrieving the look-ahead request data from a memory device, such as a shared memory, such as in block 1408.

In block 1502, the processing device may receive a cache access request before completion of the processing of a look-ahead request. The cache access request may include a request for the same data as the look-ahead request.

In block 1504, the processing device may queue the cache access request. In various aspects, the queue may be implemented in similar manners to the queue described with reference to block 1406 of the method 1400 in FIG. 14.

In block 1506, the processing device may retrieve the look-ahead request data from the cache. In various aspects, the retrieving look-ahead request data from the cache may be implemented in similar manners to retrieving look-ahead request data from the cache described with reference to block 906 in the method 900 in FIG. 9.

In block 1508, the processing device may remove the cache access request from the queue for processing the cache access request.

In block 1510, the processing device may transmit the look-ahead request data to the device, such as an I/O device, that sent the cache access request received by the processing device. The transmission of the look-ahead request data may be configured as a response with return data to the cache access request.

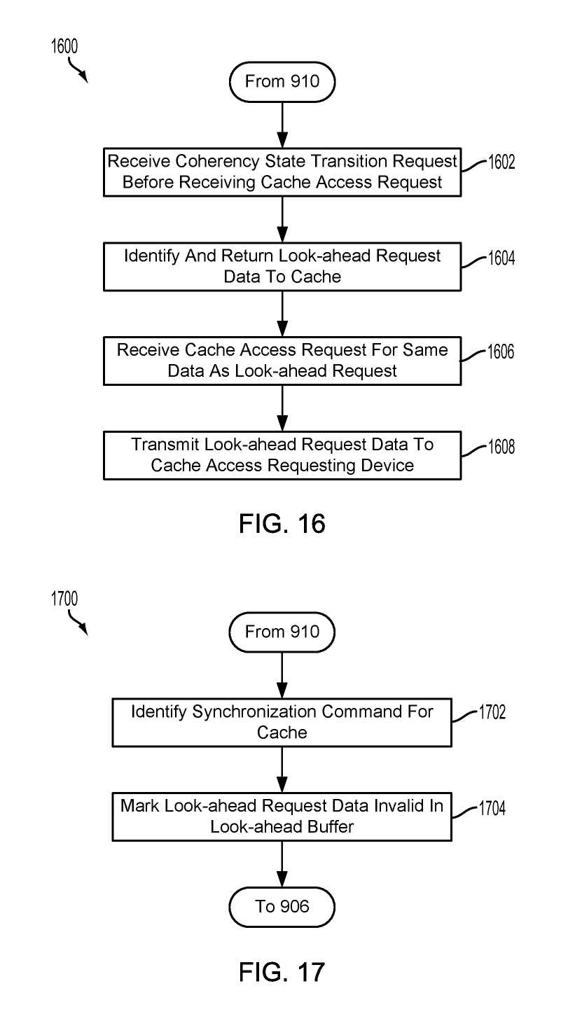

FIG. 16 illustrates a method 1600 for implementing input/output-coherent look-ahead cache access according to an aspect. The method 1600 may be implemented in a computing device in software executing in a processor (e.g., processor 14 in FIGS. 1-3, CPU cluster 406, GPU 410, DSP 412, 414, camera subsystem 418, video subsystem 420, display subsystem 422 in FIG. 4, I/O device 502, 514 in FIGS. 5-8D), in general purpose hardware, in dedicated hardware (e.g., look-ahead device 508 in FIGS. 5-8D), or in a combination of a software-configured processor and dedicated hardware, such as a processor executing software within a memory management system that includes other individual components (e.g., memory 16, 24 in FIG. 1, dedicated cache memories 204, 206, 208, 210 and shared cache memories 212, 214 in FIGS. 2 and 3, system cache 402, random access memory 428 in FIG. 4, shared memory 504, look-ahead device buffer 510 in FIGS. 5-8D, and various memory/cache controllers). In order to encompass the alternative configurations enabled in the various aspects, the hardware implementing the method 1600 is referred to herein as a “processing device.” Further, portions of the methods 900, 1000, 1100, 1200, 1300, 1400, 1500, 1600, 1700, 1800, 1900, and 2000 in FIGS. 9-20 may be implemented in response to and parallel with each other.

In various aspects, the method 1600 may begin execution any time after storing the look-ahead request data to a memory device, such as in block 910 and block 1206, and before receiving a cache access request, such as in block 1002 and block 1208.

In block 1602, the processing device may receive a coherency state transition request for a location in the cache corresponding to a location in the cache of a prior look-ahead request. In various aspects, the coherency state transition request may be directed to a device other than the processing device, such as a cache. The processing device may be communicatively connected to a communication bus, such as an interconnect bus, and the processing device may receive or intercept the coherency state transition request along the communication path to the cache. Herein, in relation to the coherency state transition request, the terms receive and intercept are used interchangeably. In various aspects, receiving a coherency state transition request may include receiving a shared memory access request from an I/O cache device.

In block 1604, the processing device may identify the location of the cache specified by the coherency state transition request as corresponding with look-ahead request data stored in a memory device, such as a buffer, and return the look-ahead request data to the cache in response to the coherency state transition request. The coherency state transition request may modify that state of the returned data stored in the cache, such as from invalid or shared states to modified or exclusive states, making the data stored in the memory device stale.

In block, 1606, the processing device may receive a cache access request for the same data as the prior look-ahead request.

In block 1608, the processing device may transmit the stale look-ahead request data to the device, such as an I/O device, that sent the cache access request received by the processing device. The transmission of the stale look-ahead request data may be configured as a response with return data to the cache access request.

FIG. 17 illustrates a method 1700 for implementing input/output-coherent look-ahead cache access according to an aspect. The method 1700 may be implemented in a computing device in software executing in a processor (e.g., processor 14 in FIGS. 1-3, CPU cluster 406, GPU 410, DSP 412, 414, camera subsystem 418, video subsystem 420, display subsystem 422 in FIG. 4, I/O device 502, 514 in FIGS. 5-8D), in general purpose hardware, in dedicated hardware (e.g., look-ahead device 508 in FIGS. 5-8D), or in a combination of a software-configured processor and dedicated hardware, such as a processor executing software within a memory management system that includes other individual components (e.g., memory 16, 24 in FIG. 1, dedicated cache memories 204, 206, 208, 210 and shared cache memories 212, 214 in FIGS. 2 and 3, system cache 402, random access memory 428 in FIG. 4, shared memory 504, look-ahead device buffer 510 in FIGS. 5-8D, and various memory/cache controllers). In order to encompass the alternative configurations enabled in the various aspects, the hardware implementing the method 1700 is referred to herein as a “processing device.” Further, portions of the methods 900, 1000, 1100, 1200, 1300, 1400, 1500, 1600, 1700, 1800, 1900, and 2000 in FIGS. 9-20 may be implemented in response to and parallel with each other.

In various aspects, the method 1700 may begin execution any time after storing the look-ahead request data to a memory device, such as in block 910 and block 1206, and before receiving a cache access request, such as in block 1002, block 1208, and block 1606.

In block 1702, the processing device may identify a synchronization command for the cache. In various aspects, the cache may receive a synchronization command to synchronize the data stored in the cache with the data stored in other memory devices, such as other caches and/or a shared memory. The processing device may be communicatively connected to the cache and monitor for such synchronization commands. In various aspects, the processing device may receive/intercept and forward the synchronization commands and/or monitor for indications of such synchronization commands.

In response to identifying a synchronization command for the cache, in block 1704, the processing device may mark the look-ahead request data retrieved from the cache and stored to a memory device, such as a buffer, as invalid in the memory device. Marking the data invalid may be implemented in a manner similar to when evicting the look-ahead request data from the memory device as described with reference to block 914 of the method 900 in FIG. 9, including options to overwrite the data and/or deenergize the memory device. The processing device may refresh the stale look-ahead request data in the memory device by retrieving the look-ahead request data from the cache in block 906 of the method 900 in FIG. 9.

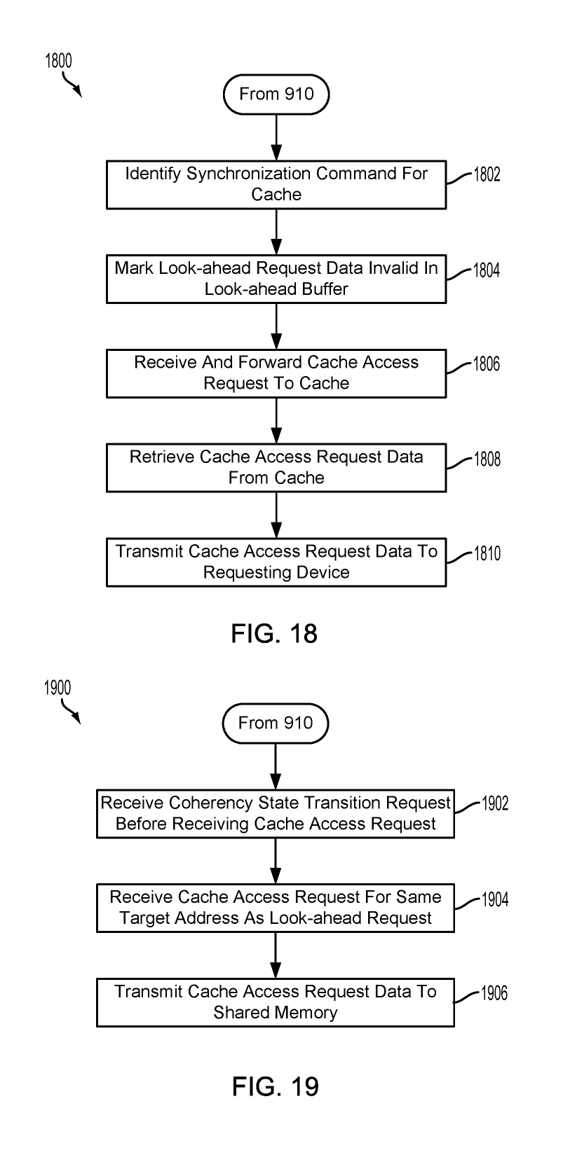

FIG. 18 illustrates a method 1800 for implementing input/output-coherent look-ahead cache access according to an aspect. The method 1800 may be implemented in a computing device in software executing in a processor (e.g., processor 14 in FIGS. 1-3, CPU cluster 406, GPU 410, DSP 412, 414, camera subsystem 418, video subsystem 420, display subsystem 422 in FIG. 4, I/O device 502, 514 in FIGS. 5-8D), in general purpose hardware, in dedicated hardware (e.g., look-ahead device 508 in FIGS. 5-8D), or in a combination of a software-configured processor and dedicated hardware, such as a processor executing software within a memory management system that includes other individual components (e.g., memory 16, 24 in FIG. 1, dedicated cache memories 204, 206, 208, 210 and shared cache memories 212, 214 in FIGS. 2 and 3, system cache 402, random access memory 428 in FIG. 4, shared memory 504, look-ahead device buffer 510 in FIGS. 5-8D, and various memory/cache controllers). In order to encompass the alternative configurations enabled in the various aspects, the hardware implementing the method 1800 is referred to herein as a “processing device.” Further, portions of the methods 900, 1000, 1100, 1200, 1300, 1400, 1500, 1600, 1700, 1800, 1900, and 2000 in FIGS. 9-20 may be implemented in response to and parallel with each other.

In various aspects, the method 1800 may begin execution any time after storing the look-ahead request data to a memory device, such as in block 910 and block 1206, and before receiving a cache access request, such as in block 1002, block 1208, and block 1606. In block 1802, the processing device may identify a synchronization command for the cache. In various aspects, may identify the synchronization command for the cache in similar manners as described with reference to block 1702 of the method 1700 in FIG. 17.

In response to identifying a synchronization command for the cache, in block 1804, the processing device may mark the look-ahead request data retrieved from the cache and stored to a memory device, such as a buffer, as invalid in the memory device. Marking the data as invalid may be implemented in a manner similar to when evicting the look-ahead request data from the memory device as described with reference to block 914 of the method 900 in FIG. 9, including options to overwrite the data and/or deenergize the memory device.

In block 1806, the processing device may receive a cache access request for a device, such as an I/O device and send the cache access request to the cache. Rather than responding to the cache access request with stale look-ahead request data or updating the stale look-ahead request data, the processing device may retrieve the updated data matching the location of the look-ahead data and the cache access data in the cache.

In block 1808, the processing device may retrieve the cache access request data from the cache.

In block 1810, the processing device may transmit the cache access request data to the device that sent the cache access request received by the processing device. The transmission of the cache access request data may be configured as a response with return data to the cache access request.

FIG. 19 illustrates a method 1900 for implementing input/output-coherent look-ahead cache access according to an aspect. The method 1900 may be implemented in a computing device in software executing in a processor (e.g., processor 14 in FIGS. 1-3, CPU cluster 406, GPU 410, DSP 412, 414, camera subsystem 418, video subsystem 420, display subsystem 422 in FIG. 4, I/O device 502, 514 in FIGS. 5-8D), in general purpose hardware, in dedicated hardware (e.g., look-ahead device 508 in FIGS. 5-8D), or in a combination of a software-configured processor and dedicated hardware, such as a processor executing software within a memory management system that includes other individual components (e.g., memory 16, 24 in FIG. 1, dedicated cache memories 204, 206, 208, 210 and shared cache memories 212, 214 in FIGS. 2 and 3, system cache 402, random access memory 428 in FIG. 4, shared memory 504, look-ahead device buffer 510 in FIGS. 5-8D, and various memory/cache controllers). In order to encompass the alternative configurations enabled in the various aspects, the hardware implementing the method 1900 is referred to herein as a “processing device.” Further, portions of the methods 900, 1000, 1100, 1200, 1300, 1400, 1500, 1600, 1700, 1800, 1900, and 2000 in FIGS. 9-20 may be implemented in response to and parallel with each other.

In various aspects, the method 1900 may begin execution any time after storing the target address in the cache of the cache access request to a memory device, such as in block 910 and block 1206, and before receiving a cache access request, such as in block 1002 and block 1208.

In block 1902, the processing device may receive a coherency state transition request for a location in the cache corresponding to a location in the cache of a prior look-ahead request. In various aspects, the coherency state transition request may be directed to a device other than the processing device, such as a cache. The processing device may be communicatively connected to a communication bus, such as an interconnect bus, and the processing device may receive or intercept the coherency state transition request along the communication path to the cache. The terms receive and intercept are used interchangeably herein in relation to the coherency state transition request. In various aspects, receiving a coherency state transition request may include receiving a shared memory access request from a cache. The coherency state transition request may prompt a shared memory to return data to the cache, and may modify that state of the returned data stored in the cache, such as from invalid or shared states to modified or exclusive states.

In block 1904, the processing device may receive a cache access request for the same target address in the cache as the prior look-ahead request.

In block 1906, the processing device may transmit the cache access request to the shared memory. In various aspects, the shared memory may return the data of the cache access request to a requesting processing device issuing the cache access request either directly or via the processing device.

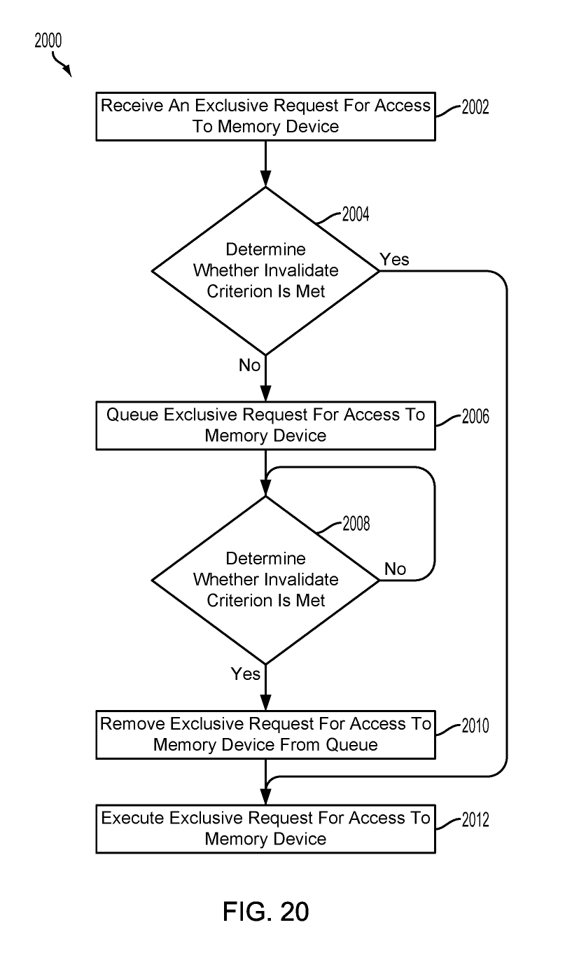

FIG. 20 illustrates a method 2000 for implementing input/output-coherent look-ahead cache access according to an aspect. The method 2000 may be implemented in a computing device in software executing in a processor (e.g., processor 14 in FIGS. 1-3, CPU cluster 406, GPU 410, DSP 412, 414, camera subsystem 418, video subsystem 420, display subsystem 422 in FIG. 4, I/O device 502, 514 in FIGS. 5-8D), in general purpose hardware, in dedicated hardware (e.g., look-ahead device 508 in FIGS. 5-8D), or in a combination of a software-configured processor and dedicated hardware, such as a processor executing software within a memory management system that includes other individual components (e.g., memory 16, 24 in FIG. 1, dedicated cache memories 204, 206, 208, 210 and shared cache memories 212, 214 in FIGS. 2 and 3, system cache 402, random access memory 428 in FIG. 4, shared memory 504, look-ahead device buffer 510 in FIGS. 5-8D, and various memory/cache controllers). In order to encompass the alternative configurations enabled in the various aspects, the hardware implementing the method 2000 is referred to herein as a “processing device.” Further, portions of the methods 900, 1000, 1100, 1200, 1300, 1400, 1500, 1600, 1700, 1800, 1900, and 2000 in FIGS. 9-20 may be implemented in response to and parallel with each other.

In various aspects, the method 2000 may begin execution any time after storing the look-ahead request data to a memory device, such as in block 910 and block 1206, and before receiving a cache access request, such as in block 1002 and block 1208.

In block 2002, the processing device may receive an exclusive request for access to a memory device, such as a buffer or cache associated with the processing device. In various aspects, the memory device may be fully coherent. The exclusive request may include a write request to the memory device and an invalidate request for the memory device. The write and invalidate requests may be for the same location in the memory device.

In determination block 2004, the processing device may determine whether an invalidate criterion is met. In various aspects, the invalidate criterion may include prior receipt of a cache access request for the data stored in the memory device at same location as a location specified by the exclusive request, or whether a threshold, such as a designated period of time or a counter value, is reached.

In response to determining that the invalidate criterion is met (i.e., determination block 2004=“Yes”), the processing device may execute the exclusive request in block 2012. As part of the execution of the exclusive request in block 2012, the processing device may mark or prompt the memory device to mark the requested data stored in the memory device as invalid.

In response to determining that the invalidate criterion is not met (i.e., determination block 2004=“No”), the processing device may queue the exclusive request in block 2006.

In determination block 2008, the processing device may determine whether the invalidate criterion is met. Determining whether the invalidate criterion is met may be executed in a similar manner as determining whether the invalidate criterion is met in determination block 2004.

In response to determining that the invalidate criterion is not met (i.e., determination block 2008=“No”), the processing device may repeatedly determine whether the invalidate criterion is met in determination block 2008.

In response to determining that the invalidate criterion is met (i.e., determination block 2008=“Yes”), the processing device may remove the exclusive request from the queue in block 2010, and execute the exclusive request in block 2012.

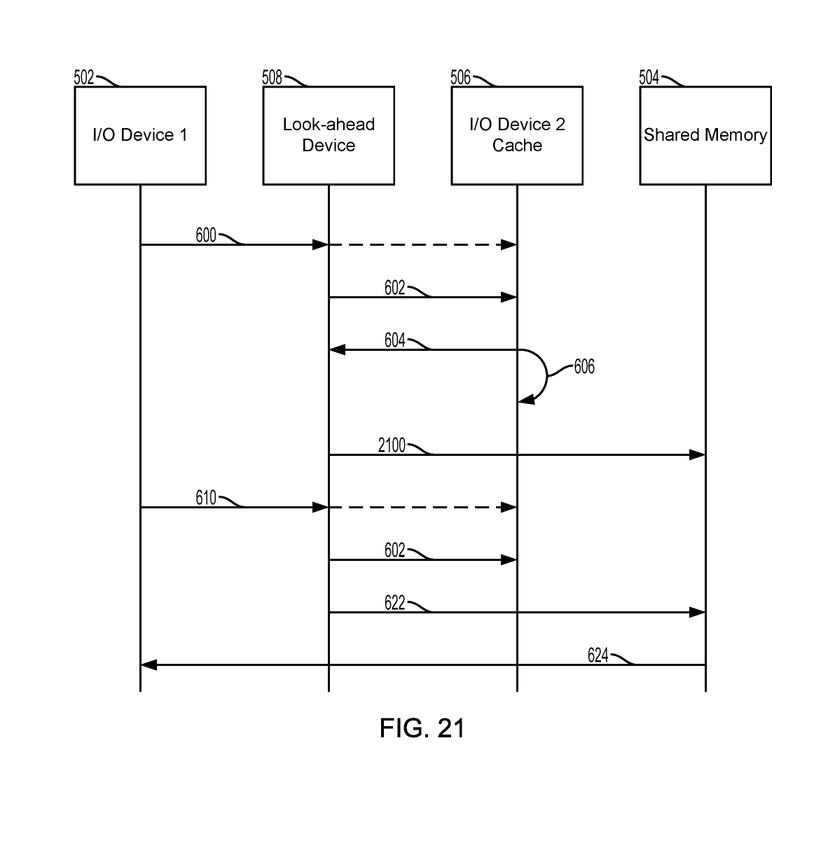

FIG. 21 illustrates an example operation flow for input/output-coherent look-ahead cache access using a look-ahead device implementing an aspect in which the look-ahead device 508 may exclude or not use the look-ahead device buffer 510. In other words, the look-ahead device 508 may be configured to process look-ahead requests and cache access requests without storing look-ahead data to the look-ahead device buffer 510. The example illustrated in FIG. 21 relates to the structures of the components illustrated in FIGS. 1-8 and 21. The I/O device 502, 514, shared memory 504, I/O device cache 506, and look-ahead device 508 are used as examples for ease of explanation and brevity, but are not meant to limit the claims to the illustrated number and/or types of I/O devices (e.g., processor 14 in FIGS. 1-3, CPU cluster 406, GPU 410, DSP 412, 414, camera subsystem 418, video subsystem 420, display subsystem 422 in FIG. 4) or memory devices (e.g., memory 16, 24 in FIG. 1, dedicated cache memories 204, 206, 208, 210 and shared cache memories 212, 214 in FIGS. 2 and 3, system cache 402, and random access memory 428 in FIG. 4). Further, the order of the operations and signals 600-606, 610, 624, and 2100 is used as an example for ease of explanation and brevity, but is not meant to limit the claims to a particular order of execution of the operations and signals 600-606, 610, 624, and 2100 as several of the operations and signals 600-606, 610, 624, and 2100 may be implemented in parallel and in other orders.

The I/O device 502 may send a look-ahead request to the I/O device cache 506. During transmission of the look-ahead request, the look-ahead device 508 may receive 600 the look-ahead request. In various aspects, the look-ahead device 508 may intercept the look-ahead request, because the look-ahead request may be targeted for receipt by the I/O device cache 506 but first captured by the look-ahead device 508 before arriving at the I/O device cache 506.

The look-ahead device 508 may check 602 whether the I/O device cache 506 contains the requested data at the location in the I/O device cache 506 specified by the look-ahead request. Checking 602 the I/O device cache location may include the process of snooping the location of the I/O device cache 506. In response to determining from the check 602 that the I/O device cache 506 contains the requested data at the location in the I/O device cache 506 specified by the look-ahead request, the look-ahead device 508 may retrieve 604 the requested data from the I/O device cache 506. In various aspects, the look-ahead device 508 may retrieve 604 the requested data by requesting the data from the I/O device cache 506 and receiving a return data response from the I/O device cache 506. The request for the data from the I/O device cache 506 may also include a request to mark the data in the I/O device cache 506 as invalid. Responding to the request to check for the data of the look-ahead device 508 with the return data or indication response may prompt the I/O device cache 506 to mark 606 the data in the cache as invalid or shared. After receiving the return data or indication response from the I/O device cache 506, the look-ahead device 508 may send 2100 the retrieved data to the shared memory 504 for storage. Sending 2100 the data to the shared memory 504 may include sending a write command to the shared memory 504 for the data.

The I/O device 502 may send a cache access request to the I/O device cache 506. During transmission of the cache access request, the look-ahead device 508 may receive 610 the cache access request. In various aspects, the look-ahead device 508 may intercept the cache access request, because the cache access request may be targeted for receipt by the I/O device cache 506 but first captured by the look-ahead device 508 before arriving at the I/O device cache 506.

The look-ahead device 508 may check 602 whether the I/O device cache 506 contains the requested data at the location in the I/O device cache 506 specified by the look-ahead request. Checking 602 the I/O device cache location may include the process of snooping the location of the I/O device cache 506. In various aspects, the look-ahead device 508 may snoop the I/O device cache 506 through a snoop filter configured to track coherency states of the locations in the I/O device cache 506. Using the snoop filter may allow the look-ahead device 508 to first check the coherency state of the location in the I/O device cache 506 specified by the cache access request. Since cache locations of look-ahead requests are marked invalid in the I/O device cache 506, the snoop filter may indicate that a coherency state is invalid for a location in the I/O device cache 506 that is the same for a cache access request and an earlier look-ahead request. The look-ahead device may forego snooping the location in the I/O device cache 506 specified by the cache access request in response to the snoop filter indicating that the coherency state is invalid for the location in the I/O device cache 506. Obviating the need to snoop the I/O device cache 506 for locations that are subject to a look-ahead request may reduce average access latency for cache access requests to the I/O device cache 506.

The look-ahead device 508 may send 622 the cache access request to the shared memory 504. In various aspects, the look-ahead device 508 may send or forward the received cache access request by duplicating and sending the message signals of the cache access request. The shared memory 504 may locate the requested data in the shared memory 504, and return 624 the requested data to the I/O device 502 that originally issued the cache access request. In various aspects, the return 624 of the requested data may be direct between the shared memory 504 and the I/O device 502 because the return 624 of the requested data does not affect anything for the look-ahead buffer 510. This direct return 624 may be possible because of the duplication of the messaging signals of the cache access request that may identify the I/O device 502 as the source of the cache access request. In various aspects, the return 624 of the requested data may be routed through the look-ahead device 508.

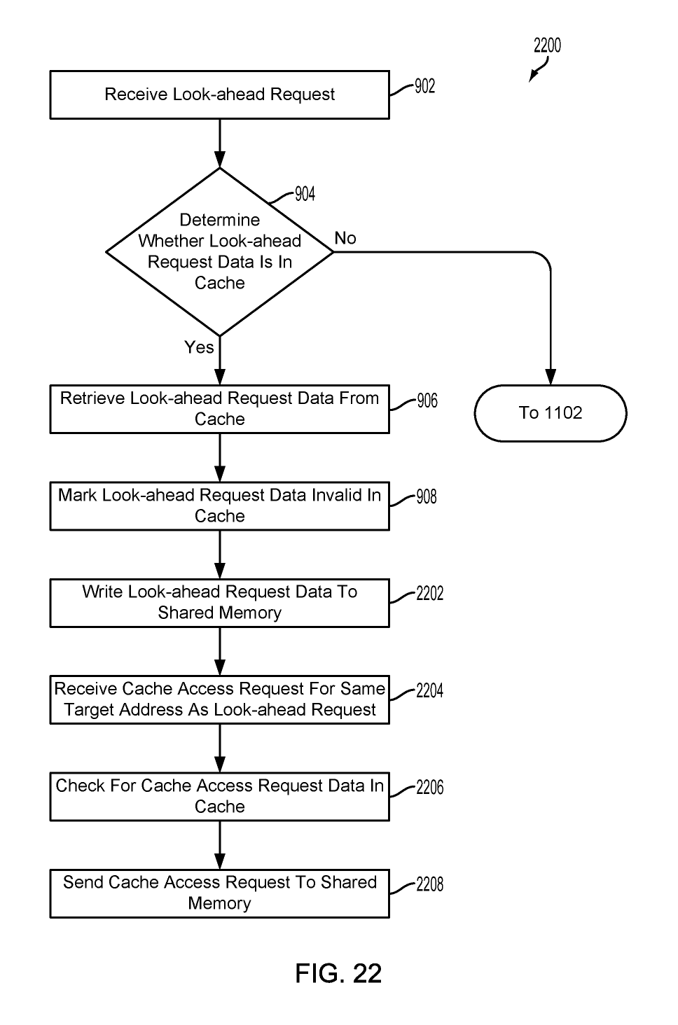

FIG. 22 illustrates a method 2200 for implementing input/output-coherent look-ahead cache access according to an aspect. The method 2200 may be implemented in a computing device in software executing in a processor (e.g., processor 14 in FIGS. 1-3, CPU cluster 406, GPU 410, DSP 412, 414, camera subsystem 418, video subsystem 420, display subsystem 422 in FIG. 4, I/O device 502, 514 in FIGS. 5-8D and FIG. 21), in general purpose hardware, in dedicated hardware (e.g., look-ahead device 508 in FIGS. 5-8D and 21), or in a combination of a software-configured processor and dedicated hardware, such as a processor executing software within a memory management system that includes other individual components (e.g., memory 16, 24 in FIG. 1, dedicated cache memories 204, 206, 208, 210 and shared cache memories 212, 214 in FIGS. 2 and 3, system cache 402, random access memory 428 in FIG. 4, shared memory 504 in FIGS. 5-8D and 21, and various memory/cache controllers). In order to encompass the alternative configurations enabled in the various aspects, the hardware implementing the method 2200 is referred to herein as a “processing device.” Further, portions of the methods 900, 1000, 1100, 1200, 1300, 1400, 1500, 1600, 1700, 1800, 1900, 2000, and 2200 in FIGS. 9-20 and 22 may be implemented in response to and parallel with each other.

In various aspects, block 902, block 9004, block 906, and block 908 may be implemented as described for the method 900 with reference to FIG. 9. In block 902, the processing device may receive a look-ahead request. In various aspects, the processing device may receive or intercept the look-ahead request along the communication path to the cache.

In determination block 904, the processing device may determine whether the look-ahead request data is stored in the cache. In response to determining that the look-ahead request data is not stored in the cache (i.e., determination block 904=“No”), the processing device may execute various functions, such as the functions described with reference to block 1102 of the method 1100 in FIG. 11.

In response to determining that the look-ahead request data is stored in the cache (i.e., determination block 904=“Yes”), the processing device may retrieve the look-ahead request data from the cache in optional block 906. In various aspects, the processing device may retrieve data from the cache by sending an exclusive read request, which may prompt the cache to return specific data in response to the request and may prompt the cache to mark locations of the data returned in response to the read request as invalid or shared in block 908.

In block 2202, the processing device may write the look-ahead request data to a memory device, such as a shared memory. The processing device may not have direct access to the shared memory and may send a write request to a shared memory manager to write the look-ahead request data to the shared memory.

In block 2204, the processing device may receive a cache access request for the same target address in the cache as the prior look-ahead request.

In block 2206, the processing device may check for the data of the cache access request in the cache. In various aspects, the cache access request may specify a location for the requested data the cache and the processing device may check the cache location. Checking the cache location may include the process of snooping the cache location. In various aspects, the processing device may snoop the cache through a snoop filter configured to track coherency states of the locations in the cache. Using the snoop filter may allow the look-ahead device 508 to first check the coherency state of the location in the cache specified by the cache access request. Since cache locations of look-ahead requests are marked invalid in block 908, the snoop filter may indicate that a coherency state is invalid for a cache location that is the same for a cache access request and an earlier look-ahead request. The processing device may forego snooping the cache location in the cache in response to the snoop filter indicating that the coherency state is invalid for the cache location.

In block 2208, the processing device may send the cache access request to a memory device, such as the shared memory. In various aspects, sending or forwarding the received cache access request may be accomplished by duplicating and sending message signals of the cache access request.

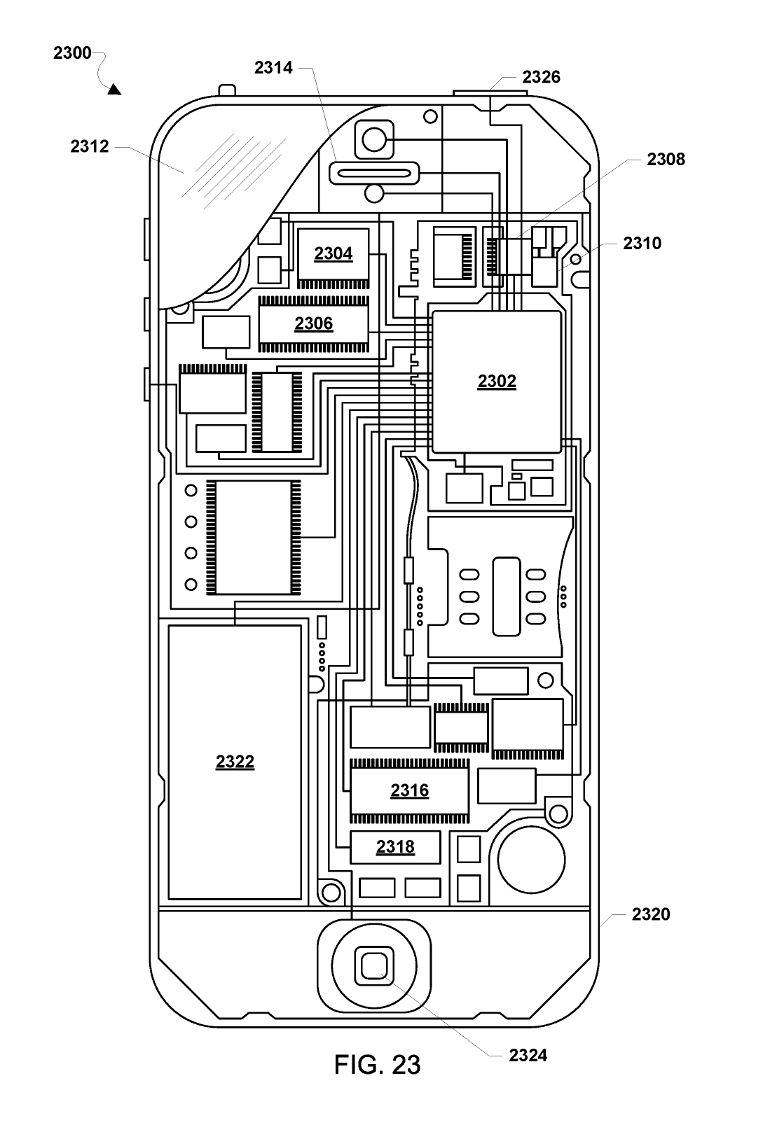

The various aspects (including, but not limited to, aspects described above with reference to FIGS. 1-22) may be implemented in a wide variety of computing systems including mobile computing devices, an example of which suitable for use with the various aspects is illustrated in FIG. 23. The mobile computing device 2300 may include a processor 2302 coupled to a touchscreen controller 2304 and an internal memory 2306. The processor 2302 may be one or more multicore integrated circuits designated for general or specific processing tasks. The internal memory 2306 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 2304 and the processor 2302 may also be coupled to a touchscreen panel 2312, such as a resistive-sensing touchscreen, capacitive-sensing touchscreen, infrared sensing touchscreen, etc. Additionally, the display of the computing device 2300 need not have touch screen capability.

The mobile computing device 2300 may have one or more radio signal transceivers 2308 (e.g., Peanut, Bluetooth, ZigBee, Wi-Fi, RF radio) and antennae 2310, for sending and receiving communications, coupled to each other and/or to the processor 2302. The transceivers 2308 and antennae 2310 may be used with the above-mentioned circuitry to implement the various wireless transmission protocol stacks and interfaces. The mobile computing device 2300 may include a cellular network wireless modem chip 2316 that enables communication via a cellular network and is coupled to the processor.

The mobile computing device 2300 may include a peripheral device connection interface 2318 coupled to the processor 2302. The peripheral device connection interface 2318 may be singularly configured to accept one type of connection, or may be configured to accept various types of physical and communication connections, common or proprietary, such as Universal Serial Bus (USB), FireWire, Thunderbolt, or PCIe. The peripheral device connection interface 2318 may also be coupled to a similarly configured peripheral device connection port (not shown).

The mobile computing device 2300 may also include speakers 2314 for providing audio outputs. The mobile computing device 2300 may also include a housing 2320, constructed of a plastic, metal, or a combination of materials, for containing all or some of the components described herein. The mobile computing device 2300 may include a power source 2322 coupled to the processor 2302, such as a disposable or rechargeable battery. The rechargeable battery may also be coupled to the peripheral device connection port to receive a charging current from a source external to the mobile computing device 2300. The mobile computing device 2300 may also include a physical button 2324 for receiving user inputs. The mobile computing device 2300 may also include a power button 2326 for turning the mobile computing device 2300 on and off.

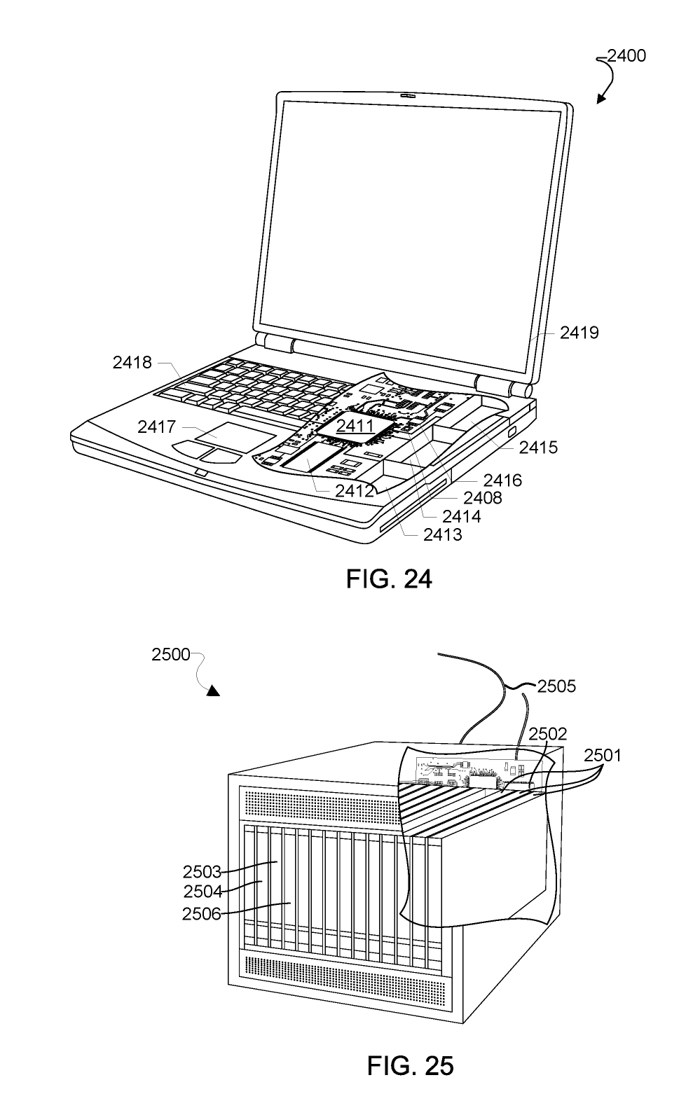

The various aspects (including, but not limited to, aspects described above with reference to FIGS. 1-22) may be implemented in a wide variety of computing systems include a laptop computer 2400 an example of which is illustrated in FIG. 24. Many laptop computers include a touchpad touch surface 2417 that serves as the computer's pointing device, and thus may receive drag, scroll, and flick gestures similar to those implemented on computing devices equipped with a touch screen display and described above. A laptop computer 2400 will typically include a processor 2411 coupled to volatile memory 2412 and a large capacity nonvolatile memory, such as a disk drive 2413 of Flash memory. Additionally, the computer 2400 may have one or more antenna 2408 for sending and receiving electromagnetic radiation that may be connected to a wireless data link and/or cellular telephone transceiver 2416 coupled to the processor 2411. The computer 2400 may also include a floppy disc drive 2414 and a compact disc (CD) drive 2415 coupled to the processor 2411. In a notebook configuration, the computer housing includes the touchpad 2417, the keyboard 2418, and the display 2419 all coupled to the processor 2411. Other configurations of the computing device may include a computer mouse or trackball coupled to the processor (e.g., via a USB input) as are well known, which may also be used in conjunction with the various aspects.

The various aspects (including, but not limited to, aspects described above with reference to FIGS. 1-22) may also be implemented in fixed computing systems, such as any of a variety of commercially available servers. An example server 2500 is illustrated in FIG. 25. Such a server 2500 typically includes one or more multicore processor assemblies 2501 coupled to volatile memory 2502 and a large capacity nonvolatile memory, such as a disk drive 2504. As illustrated in FIG. 25, multicore processor assemblies 2501 may be added to the server 2500 by inserting them into the racks of the assembly. The server 2500 may also include a floppy disc drive, compact disc (CD) or digital versatile disc (DVD) disc drive 2506 coupled to the processor 2501. The server 2500 may also include network access ports 2503 coupled to the multicore processor assemblies 2501 for establishing network interface connections with a network 2505, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various aspects may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various aspects may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects and implementations without departing from the scope of the claims. Thus, the present disclosure is not intended to be limited to the aspects and implementations described herein, but is to be accorded the widest scope consistent with the following claims and the principles and novel features disclosed herein.

What is claimed is:

1. A method of input/output-coherent look-ahead cache access on a computing device, comprising:
receiving, by a look-ahead device, a first look-ahead request for data in a cache of a first input/output (I/O) device from a second I/O device;
determining, by the look-ahead device, whether the data requested by the first look-ahead request is stored in the cache;
retrieving, by the look-ahead device, the data requested by the first look-ahead request from the cache in response to determining that the data requested by the first look-ahead request is stored in the cache; and
storing, by the look-ahead device, the retrieved data to a look-ahead buffer.

2. The method of claim 1, further comprising:
receiving, by the look-ahead device, a cache access request for data in the cache of the first I/O device from the second I/O device;
determining, by the look-ahead device, whether the data requested by the cache access request is stored in the look-ahead buffer; and
returning, by the look-ahead device, the data requested by the cache access request to the first I/O device from the look-ahead buffer in response to determining that the data requested by the cache access request is stored in the look-ahead buffer.

3. The method of claim 1, further comprising:
receiving, by the look-ahead device, a second look-ahead request for data in the cache of the first input/output (I/O) device;
determining whether the data requested by the second look-ahead request is the same as the data stored in the look-ahead buffer and requested by the first look-ahead request; and
evicting the data from the look-ahead buffer in response to determining that the data requested by the second look-ahead request is not the same as the data stored on the look-ahead buffer and requested in the first look-ahead request.

4. The method of claim 3, further comprising:
receiving, by a look-ahead device, a cache access request for data in the cache of the first I/O device from a third I/O device;
determining whether the data requested by the cache access request is the same as the data requested by the first look-ahead request; and
sending, by the look-ahead device, the cache access request to a shared memory in response to determining that the data requested by the cache access request is the same as the data requested by the first look-ahead request.

5. The method of claim 1, further comprising:
receiving, by the look-ahead device, a cache access request for data in the cache of the first I/O device from the second I/O device before retrieving the data requested by the first look-ahead request from the cache, wherein the data requested by the cache access request is the same as the data requested by the first look-ahead request;
queuing the cache access request by the look-ahead device; and
returning, by the look-ahead device, the data requested by the cache access request to the first I/O device in response to retrieving the data requested by the first look-ahead request from the cache.

6. The method of claim 1, further comprising:
receiving, by the look-ahead device, a coherency state transition request from the cache for the same location in the cache as the first look-ahead request; and
returning, by the look-ahead device, the data from the look-ahead buffer to the cache.

7. The method of claim 6, further comprising:
maintaining the data in the look-ahead buffer as stale data;
receiving, by the look-ahead device, a cache access request for data in the cache of the first I/O device from the second I/O device;
determining, by the look-ahead device, whether the data requested by the cache access request is the stale data stored in the look-ahead buffer; and
returning, by the look-ahead device, the data requested by the cache access request to the first I/O device from the look-ahead buffer in response to determining that the data requested by the cache access request is the stale data stored in the look-ahead buffer.

8. The method of claim 6, further comprising:
identifying, by the look-ahead device, a synchronization command for the cache; and
marking the data stored in the look-ahead buffer as invalid.

9. The method of claim 8, further comprising:
retrieving, by the look-ahead device, the data requested by the first look-ahead request from the cache a second time in response to data stored in the look-ahead buffer being marked as invalid; and
storing, by the look-ahead device, the second time retrieved data to a look-ahead buffer.

10. The method of claim 8, further comprising:
receiving, by the look-ahead device, a cache access request for data in the cache of the first I/O device from the second I/O device; and
sending, by the look-ahead device, the cache access request to the cache.

11. A method of input/output-coherent look-ahead cache access on a computing device, comprising:
receiving, by a look-ahead device, a look-ahead request for data in a cache of a first input/output (I/O) device from a second I/O device; and
determining, by the look-ahead device, whether the data requested by the look-ahead request is stored in the cache.

12. The method of claim 11, further comprising:
dropping, by the look-ahead device, the look-ahead request in response to determining that the data requested by the look-ahead request is not stored in the cache;
receiving, by the look-ahead device, a cache access request for data in the cache of the first I/O device from the second I/O device, wherein the data requested by the cache access request is the same as the data requested by the look-ahead request; and
sending, by the look-ahead device, the cache access request to a shared memory.

13. The method of claim 11, further comprising:
sending, by the look-ahead device, the look-ahead request to a shared memory; and
receiving, by the look-ahead device, a cache access request for data in the cache of the first I/O device from the second I/O device, wherein the data requested by the cache access request is the same as the data requested by the look-ahead request.

14. The method of claim 13, further comprising:
queuing the cache access request by the look-ahead device; and
returning, by the look-ahead device, the data requested by the cache access request to the first I/O device in response to retrieving the data requested by the look-ahead request from the shared memory.

15. The method of claim 11, further comprising:
retrieving, by the look-ahead device, the data requested by the look-ahead request from the cache in response to determining that the data requested by the look-ahead request is stored in the cache;
marking the data requested by the look-ahead request in the cache as invalid;
sending, by the look-ahead device, a shared memory access request to write the data requested by the look-ahead request to a shared memory;
receiving, by the look-ahead device, a cache access request for data in the cache of the first I/O device from the second I/O device, wherein the data requested by the cache access request is the same as the data requested by the look-ahead request;
determining, by the look-ahead device, whether the data requested by the cache access request is stored in the cache; and
sending, by the look-ahead device, the cache access request to a shared memory in response to determining that the data requested by the cache access request is not stored in the cache.

16. A computing device, comprising:
a look-ahead device having a look-ahead buffer;
a first input/output (I/O) device having a cache; and
a second I/O device;
wherein the look-ahead device is configured to perform operations comprising:
receiving a first look-ahead request for data in a cache of the first I/O device from the second I/O device;
determining whether the data requested by the first look-ahead request is stored in the cache;
retrieving the data requested by the first look-ahead request from the cache in response to determining that the data requested by the first look-ahead request is stored in the cache; and
storing the retrieved data to a look-ahead buffer.

17. The computing device of claim 16, wherein the look-ahead device is further configured to perform operations comprising:
receiving a cache access request for data in the cache of the first I/O device from the second I/O device;
determining whether the data requested by the cache access request is stored in the look-ahead buffer; and
returning the data requested by the cache access request to the first I/O device from the look-ahead buffer in response to determining that the data requested by the cache access request is stored in the look-ahead buffer.

18. The computing device of claim 16, wherein the look-ahead device is configured to perform operations comprising:
receiving a second look-ahead request for data in the cache of the first input/output (I/O) device;
determining whether the data requested by the second look-ahead request is the same as the data stored in the look-ahead buffer and requested by the first look-ahead request; and
evicting the data from the look-ahead buffer in response to determining that the data requested by the second look-ahead request is not the same as the data stored on the look-ahead buffer and requested in the first look-ahead request.

19. The computing device of claim 18, wherein the look-ahead device is configured to perform operations comprising:
receiving a cache access request for data in the cache of the first I/O device from a third I/O device;
determining whether the data requested by the cache access request is the same as the data requested by the first look-ahead request; and
sending the cache access request to a shared memory in response to determining that the data requested by the cache access request is the same as the data requested by the first look-ahead request.

20. The computing device of claim 16, wherein the look-ahead device is configured to perform operations comprising:
receiving a cache access request for data in the cache of the first I/O device from the second I/O device before retrieving the data requested by the first look-ahead request from the cache, wherein the data requested by the cache access request is the same as the data requested by the first look-ahead request;
queuing the cache access request by the look-ahead device; and
returning the data requested by the cache access request to the first I/O device in response to retrieving the data requested by the first look-ahead request from the cache.

21. The computing device of claim 20, wherein the look-ahead device is configured to perform operations comprising:
receiving a coherency state transition request from the cache for the same location in the cache as the first look-ahead request; and
returning the data from the look-ahead buffer to the cache.

22. The computing device of claim 21, further comprising:
maintaining the data in the look-ahead buffer as stale data;
receiving a cache access request for data in the cache of the first I/O device from the second I/O device;
determining whether the data requested by the cache access request is the stale data stored in the look-ahead buffer; and
returning the data requested by the cache access request to the first I/O device from the look-ahead buffer in response to determining that the data requested by the cache access request is the stale data stored in the look-ahead buffer.

23. The computing device of claim 21, wherein the look-ahead device is configured to perform operations comprising:
identifying a synchronization command for the cache; and
marking the data stored in the look-ahead buffer as invalid.

24. The computing device of claim 23, wherein the look-ahead device is configured to perform operations comprising:
retrieving the data requested by the first look-ahead request from the cache a second time in response to data stored in the look-ahead buffer being marked as invalid; and
storing the second time retrieved data to a look-ahead buffer.

25. The computing device of claim 23, wherein the look-ahead device is configured to perform operations comprising:
receiving a cache access request for data in the cache of the first I/O device from the second I/O device; and
sending the cache access request to the cache.

26. A computing device, comprising:
a look-ahead device having a look-ahead buffer;
a first input/output (I/O) device having a cache; and
a second I/O device;
wherein the look-ahead device is configured to perform operations comprising:
receiving a look-ahead request for data in a cache of a first input/output (I/O) device from a second I/O device; and
determining whether the data requested by the look-ahead request is stored in the cache.

27. The computing device of claim 26, wherein the look-ahead device is configured to perform operations comprising:
dropping the look-ahead request in response to determining that the data requested by the look-ahead request is not stored in the cache;
receiving a cache access request for data in the cache of the first I/O device from the second I/O device, wherein the data requested by the cache access request is the same as the data requested by the look-ahead request; and
sending the cache access request to a shared memory.

28. The computing device of claim 26, wherein the look-ahead device is configured to perform operations comprising:
sending the look-ahead request to a shared memory; and
receiving a cache access request for data in the cache of the first I/O device from the second I/O device, wherein the data requested by the cache access request is the same as the data requested by the look-ahead request.

29. The computing device of claim 28, wherein the look-ahead device is configured to perform operations comprising:
queuing the cache access request by the look-ahead device; and
returning the data requested by the cache access request to the first I/O device in response to retrieving the data requested by the look-ahead request from the shared memory.

30. The computing device of claim 26, wherein the look-ahead device is configured to perform operations comprising:
retrieving the data requested by the look-ahead request from the cache in response to determining that the data requested by the look-ahead request is stored in the cache;
marking the data requested by the look-ahead request in the cache as invalid;
sending a shared memory access request to write the data requested by the look-ahead request to a shared memory;
receiving a cache access request for data in the cache of the first I/O device from the second I/O device, wherein the data requested by the cache access request is the same as the data requested by the look-ahead request;
determining whether the data requested by the cache access request is stored in the cache; and
sending the cache access request to a shared memory in response to determining that the data requested by the cache access request is not stored in the cache.
